(19) United States
(12) Patent Application Publication
(10) Pub. No.: US 2026/0202884 A1
(43) Pub. Date: Jul. 16, 2026

(54) OPTICAL SENSOR AND METHODS OF INITIALISING AND CALIBRATING AN OPTICAL SENSOR

(71) Applicant: Nordiq Products AS, Trondheim (NO)

(72) Inventor: Lise Lyngsnes Randeberg, Trondheim (NO)

(21) Appl. No.: 19/128,082

(22) PCT Filed: Nov. 8, 2022
(86) PCT No.: PCT/EP2023/081215

§ 371 Date: May 7, 2025

(30) Foreign Application Priority Data
Nov. 8, 2022 (GB) 2216625.0
Nov. 8, 2022 (GB) 2216634.2
Nov. 8, 2022 (GB) 2216636.7
Nov. 8, 2022 (GB) 2216639.1

(51) Int. Cl. G06F 1/16; G06F 1/08; G06F 3/01; H05B 47/105; H05B 47/16

(52) U.S. Cl. CPC G06F 1/1686; G06F 1/08; G06F 1/163; G06F 3/011; H05B 47/105; H05B 47/16

(57) ABSTRACT

There is provided a method of calibrating an optical sensor for measuring one or more physiological signs of a person after the device is attached to the person, the sensor comprising one or more detectors 15 and one more light sources. The method comprises the following steps after the device is attached to the person: emitting one or more light pulses at a plurality of different wavelengths using one or more light sources wherein each light pulse at each wavelength is emitted at a known power level and for a known length time; recording a signal for the light pulses at each wavelength using one or more detectors to create an optical signature of the person; and selecting one or more wavelengths of the plurality of wavelengths based on the optical signature of the person to be used when measuring the one or more physiological signs.

### FIELD OF THE INVENTION

The present invention relates to an optical sensor for use in measuring one or more physiological signs in a person. The invention further extends to a method of initialising an optical sensor for use in measuring one or more physiological signs in a person and/or methods of calibrating an optical sensor for use in measuring one or more physiological signs in a person.

### BACKGROUND

Optical sensors, such as photoplethysmogram (PPG) sensors, are used in monitoring devices for monitoring vital signs such as blood oxygen saturation, pulse rate, breathing rate etc. The physiological signs may include one or more vital signs.

An example vital signs monitoring device is disclosed in WO 2022/136438.

PPG sensors, such as pulse oximeters, typically comprise a photodetector and two LEDs each configured to emit light at a known wavelength. The light is emitted to illuminate the skin and blood and is then detected by the detector which determines the changing absorbance at each wavelength to allow it to determine the required vital signs.

PPG sensors can be transmissive sensors which may be used to monitor blood flow in a person's extremity such as their fingertip or earlobe. In the case of transmissive sensors, the LEDs may be positioned on one side of the patient's extremity, while the photodetector is on the other side in order to receive the light directly after passing through the patient's tissue.

Alternatively, PPG sensors can be reflectance sensors which are used to monitor blood flow in a patient's wrist using a watch, for example. In this case, the photodetector and LEDs are located adjacent to each other on the same side of the patient's tissue so that the light emitted by the sensor is reflected back towards the photodetector.

An important problem that has been identified with optical sensors for monitoring vital signs is that they may not always provide reliable measurements. This can have a serious consequence as the output from the sensor may be relied on in determining the status of a patient's health. For example, one possible problem is that the sensor may not be working optimally and this may not be known by the user of the sensor. Another known problem is that optical sensors may not perform as well on patients with certain skin tones or skin types.

There is therefore a need to provide a sensor and accompanying methods to allow more accurate and reliable measurements to be taken for a wider range of people.

### SUMMARY

Viewed from a first aspect, there is provided an optical sensor for measuring one or more physiological signs of a person, the sensor comprising: a detector; and a plurality of light sources surrounding the detector; wherein the plurality of light sources are for emitting light at a plurality of different wavelengths.

By using a plurality of light sources that surround the detector improved readings may be taken using the optical sensor. This is because the detector may be better positioned relative to the light sources to record the signals therefrom. By the light sources surrounding the detector it may be meant that the light sources are located around the periphery of the detector. The light sources may encircle the detector. The light sources may be positioned to provide a uniform light field that is detected by the detector.

By using a plurality of different wavelengths (e.g., 3 or more, 6 or more, 7 or more, 8 or more, 10 or more or exactly 8 different wavelengths), readings may be taken using more than the minimum number of wavelengths which may allow more reliable readings to be made. Additionally or alternatively, the optical sensor may be calibrated (i.e., adjusted) for different people, e.g., different skin profiles of different people. For example, optimum selected combination of wavelengths and/or light intensity for each specific person may be determined before any measurements of their physiological signs are made. This may therefore improve the accuracy of the measurements of the one or more physiological signs in people with different skin types and improve person safety accordingly.

The optical sensor may be configured to measure (e.g., monitor) one or more physiological signs of a person.

The one or more physiological signs may include one or more vital signs such as blood oxygen saturation, pulse rate and respiration rate.

The optical sensor may be configured to measure the one or more physiological signs continuously, i.e., the sensor may be configured to monitor the one or more physiological signs. The term continuously may be interpreted such one or more of the one or more physiological signs may be monitored at discrete time steps over a continuous period. The discrete time steps may comprise in the region of 1-100 ms. Alternatively, the discrete time steps may comprise up to 2 minutes, for example 30 seconds, 45 seconds, 1 minute or 90 seconds.

In addition, or as an alternative, the optical sensor may be configured to measure the one or more physiological signs at a single point in time. In other words, the optical sensor may be configured to perform a snapshot measurement of the one or more physiological signs. The optical sensor may be configured to perform the snapshot measurement when instructed by an operator. The use of a snapshot measurement may reduce the power requirements of the optical sensor as it does not need to continuously monitor the one or more physiological signs.

The optical sensor may be a pulse oximeter and may comprise a photoplethysmogram (PPG) sensor. The sensor may be a reflectance sensor such as a reflectance pulse oximeter.

The optical sensor may be a medical device for measuring one or more physiological signs of a patient. In this instance, the person may be a patient. The medical device may be a pulse oximeter for example.

Alternatively, the optical sensor may be a wearable device for measuring one or more physiological signs of a person. The wearable device may be is a smart watch or sports watch for example. The wearable device may be configured for attachment to a wrist of a person.

The detector may be or comprise a photo detector. The detector may be a camera. The camera may comprise one or more pixels.

The optical sensor may comprise a first surface, wherein each of the detector and the plurality of light sources are located on the first surface. The optical sensor may be configured such that the first surface faces towards the tissue of the person in use, i.e., when the optical sensor is attached to the person.

The optical sensor may further comprise a second surface, which may be in the opposite side of the optical sensor to the first surface. The second surface may face away from the tissue of the person in use. The second surface may comprise a display for displaying the results of measurements made by the sensor.

The optical sensor may comprise a processor. The processor may be configured to determine the one or more physiological signs. The processor may be located on or towards the second surface, i.e., the processor may be located not on the first surface. In other words the processor may be on a different surface of the optical sensor from the detector and plurality of light sources and/or within the optical sensor.

Each light source may be for emitting light at a particular wavelength. In practice each light source is for emitting light over a narrow band/peak of wavelengths, e.g., over a range of up to 20 nm about a particular wavelength. Thus references herein throughout the specification and claims to a wavelength should be interpreted as referring to a single narrow band of wavelengths (i.e., within a range of up to 20 nm from the specified wavelength). The sensor may comprise one or more light sources that are for emitting light at each wavelength. For example, the sensor may comprise two light sources that can emit light at a first wavelength and two light sources that can emit light at a second wavelength.

The plurality of light sources may comprise at least one separate light source for each wavelength of the plurality of wavelengths. For example, if the optical sensor is configured to emit six wavelengths, the optical sensor may comprise at least six light sources each for emitting a different one of the six wavelengths.

The plurality of light sources may comprise two or more separate light sources (i.e., a set of light sources) for each wavelength of the plurality of wavelength. For example, if the plurality of light sources were configured to emit six different wavelengths, the optical sensor may comprise twelve light sources, wherein each wavelength may be emitted by two separate light sources. Optionally, the plurality of light sources may comprise three or four separate light sources for each different wavelength of light (i.e., for each set of light sources). As a further example the optical sensor may comprise twenty-four separate light sources, wherein each wavelength may be emitted by four separate light sources. By providing a plurality of light sources for emitting each of the different wavelengths, the light sources may be positioned to provide a uniform light field relative to the detector.

The plurality of light sources may be arranged in one or more loops surrounding the detector (i.e., the light sources may be in one or more rings/circular formations around the detector). There may be gaps between the light sources in each loop. Thus the light sources may be positioned in one or more nominal loops that would be formed if the light sources were joined together, rather than a continuous loop of light sources. The loop(s) may each be concentric with each other and with the center of the detector. The light sources may be arranged so that all of the light sources in one loop are all equidistant from the center of the detector.

The plurality of loops may comprise an inner loop and an outer loop. The outer loop may be arranged such that each light source in the outer loop is positioned a greater distance from the center of the detector, than a light source in the inner loop. Each light source on the outer loop may be positioned a first distance from the center of the detector. Each light source on the inner loops may be positioned a second distance from the center of the detector. The second distance may be less than the first distance. The first distance may be constant around the outer loop such that each light source on the outer loop is positioned the same distance from the center of the detector as the other light sources on the outer loop. Similarly, the second distance may be constant around the inner loop such that each light source on the inner loop is positioned the same distance from the center of the detector as the other light sources on the inner loop. These distances may be from the center of the respective light source to the center of the detector.

The light sources may be arranged so that half the light sources form the inner loop and half the light sources form the outer loop.

The plurality of light sources may be arranged such the light sources arranged to emit light of a shorter wavelength is positioned on the inner loop. The plurality of light sources may be arranged such that the light sources arranged to emit light of a longer wavelength is positioned in the outer loop. In other words, the plurality of light sources arranged to emit shorter wavelengths may be located closer to the detector than the plurality of light sources arranged to emit longer wavelengths.

The plurality of light sources may be positioned within a first group of light sources and a second group of light sources, wherein the first group of light sources are located closer to the detector than the second group of light sources and wherein the light sources in the first group are configured to emit shorter wavelengths of light than the light sources in the second group of light sources. The first group of light sources may form the inner loop and the second group of light sources may form the outer loop.

It will be appreciated that reference to “shorter” and “longer” are relative terms in relation to the wavelengths selected from the plurality of wavelengths. By way of example, in the case of a plurality of wavelengths consisting of six wavelengths, the light sources arranged to emit the three shortest wavelengths may be positioned on the inner loop, meanwhile the light sources arranged to emit the three longest wavelengths may be positioned on the outer loop. A similar interpretation applies to the case where the plurality of wavelengths consists of eight wavelengths, i.e., the four shortest wavelengths are located on the inner loop, and the four longest wavelengths are located on the outer loop.

This arrangement may be beneficial as light with a longer wavelength is typically able to travel further through the tissue of the person. It can therefore be positioned further from the detector and still provide a sufficient reading. Meanwhile, the light with a shorter wavelength is emitted from a position closer to the detector so it can be detected adequately. This arrangement may allow a more compact sensor design, whilst ensuring good detection of the signals. Moreover, the use of a compact sensor design may allow for a greater number of light sources such that a greater number of wavelengths can be utilized for a given sized sensor compared to other designs.

In the case that there are a plurality of light sources (i.e., two or more) for each wavelength of light, the light sources of a particular wavelength may be located symmetrically about the detector. In other words, the light sources which may be for emitting the same wavelength may be positioned on opposite sides of the detector an equal distance from the center of the detector. The light sources which may be for emitting the same wavelength may be symmetrical about a line of symmetry which runs through the center of the detector.

For example, in the case that there are two light sources that each emit the same wavelength, they may be located on opposite sides of the detector an equal distance from the center of the detector. In this case these two light sources may be symmetrical about a line of symmetry that runs through the center of the detector between the two light sources. If there are four light sources that each emit the same wavelength, they may be located on each side of the detector (e.g., if the detector has a square shape) and each light source may be an equal distance from the center of the detector. In this case the light sources may be symmetrical about two lines of symmetry that each run through the center of the detector perpendicular to each other.

The set of light sources of every different wavelength may each be positioned symmetrically about the detector.

Such a symmetrical arrangement may allow a more uniform light field to be emitted for detection by the detector.

The plurality of light sources may be configured to emit a uniform light field about the detector. For example, light sources located directly opposite each other on either side of the detector may be mirrored. For example, the light source located on one side of the detector, may be for emitting light of the same wavelength as the light source located in the direct opposite position of the detector.

For example, one side of the detector may comprise four light sources, wherein two light sources are positioned on the inner loop and two light sources are positioned on the outer loop. In this example, the same configuration may be present on the directly opposite side of the detector, and the two light sources on the inner loop on one side may be for emitting light of the same wavelength as the two light sources on the inner loop on the other side. Similarly, the two light sources in the outer loop on one side may be for emitting light of the same wavelength as the two light sources on the outer loop on the other side.

Whilst the sensor comprises of plurality of light sources that are for emitting light at a plurality of different wavelengths, it may be the case that not all the wavelengths are used to monitor the one or more physiological signs. The determining (e.g., measuring/monitoring) of physiological signs may be performed using a subset of one or more of the plurality of wavelengths that can be emitted by the sensor. However, whilst not all of the wavelengths may be used when measuring a person's physiological signs, all of the available wavelengths may be used when initialising and/or calibrating the sensor. Calibrating the sensor may involve selecting a subset of the wavelengths to be used in measuring the physiological signs of a person.

In order to monitor blood oxygen saturation, the optical sensor may be arranged to emit and detect light at two or more of the plurality of different wavelengths of light. A first wavelength may for example be one at which the light absorption is substantially the same in oxygenated haemoglobin and deoxygenated haemoglobin (this may be referred to as an isobestic wavelength), and a second wavelength may be one at which there is a substantial difference in light absorption for oxygenated and deoxygenated haemoglobin (i.e., a non isobestic wavelength).

In order to measure pulse rate using the optical sensor, measurement of reflectance of light at a single wavelength may be sufficient. As the heart beats, blood pulses through the capillaries with the same frequency as the heartbeat. This pulsation effectively means that the volume of blood within the capillaries is changing. The changing volume in turn gives rise to a change in the amount of light absorbed by the blood, and hence the amount reflected. An estimation of the pulse rate may therefore be obtained by the optical sensor by measuring the time-dependent fluctuation in the reflected light.

It may also be possible to extract the respiration rate information using an optical sensor, because the respiratory activity affects the photoplethysmographic waveform which may be obtained.

By providing a sensor that can emit a plurality of different wavelengths, an optimum wavelength, or optimum combination of wavelengths, may be selected for each measurement depending on factors such as the skin profile of the person.

The detector may be configured to detect each of the plurality of different wavelengths. The detection of different wavelengths using the detector may be time multiplexed in correspondence with the emissions of the different wavelengths from the light sources.

The detector may be an off the shelf known PPG photodetector, i.e., the sensor may comprise a known (e.g., off the self) sensor unit.

The plurality of light sources may be configured to emit light at six or more different wavelengths. For example, the sensor may be arranged to emit light at exactly seven or eight different wavelengths. Each wavelength of light may be emitted from a different light source. Each wavelength may be able to emitted at a different time to the other wavelengths. Each light source or set of light sources (e.g., set of light sources for emitting a given wavelength) may be independently controlled. This may mean that each light source or each set of light sources may be switched on and off independently of the other light sources. The intensity of each light source (or set of light sources) may be controlled independently of the other light sources. The length of time each light source (or set of light sources) emits light may be controlled independently of the other light sources.

The plurality of wavelengths may each be within the range from 400 nm to 1300 nm, optionally with the range from 400 nm to 950 nm, optionally with the range from 460 nm and 940 nm. The plurality of wavelengths may comprise one or more of blue, dark green, light green, yellow, red, dark red and infrared light. The shortest wavelength of the plurality of wavelengths may comprise blue light. The longest wavelength of the plurality of wavelengths may comprise infrared light. The light sources may emit at least one or more wavelengths that are regarded as isobestic wavelengths of haemoglobin (e.g., 805 nm and/or 940 nm) and at least one or more wavelengths that are regarded as non-isobestic wavelengths of haemoglobin (such as 660 nm).

In use, the optical sensor may be configured to monitor the one or more physiological signs using any one or more of the plurality of wavelengths. In use, the optical sensor may be configured to monitor the one or more physiological signs using a combination of the plurality of wavelengths. The combination may be a subset of the plurality of wavelengths that can be emitted.

The plurality of light sources may comprise light emitting diodes (LEDs). Each light source may be a light emitting diode.

The optical sensor may comprise a screen (i.e., shield) configured to optically separate the detector and the plurality of light sources so that the detector does not detect light pulses directly from the plurality of light sources (i.e., without being first reflected from a surface). The screen may be positioned between the detector and the plurality of light sources. The screen may surround the detector. In the case that the light sources form one or more loops, the screen may form a loop around the detector between the light sources and the detector. The screen loop may be within the inner loop of light sources. The screen may be located at and/or extend around the periphery of the detector.

The screen may be located on the first surface of the optical sensor. The screen may protrude from the first surface in a direction perpendicular to the first surface of the optical sensor. The screen may protrude a distance sufficient to prevent light emitted from the plurality of light sources being able to be detected directly by the detector without reflecting. The screen may be opaque to all wavelengths of light emitted by the light sources. The screen may comprise plastic. In this case the plastic may be opaque.

The presence of the screen may be beneficial as it prevents any of the light emitted from the plurality of light sources being detected directly by the detector, and therefore ensures that any light detected by the detector has travelled through and/or reflected off the tissue of the person. This may improve the quality of the signal received by the detector.

As an alternative, or in addition to the use of a screen, the detector may be located within a cavity in the first surface of the optical sensor. In other words, the detector may be positioned in a recess on the surface of the optical sensor.

The sensor, e.g., screen and/or cavity of the sensor, may be configured such that there is no direct line of sight from each of the plurality of light sources and the detector.

The optical sensor may comprise a temperature sensor. The temperature sensor may be located on the first surface of the optical sensor. The temperature sensor may be positioned close to the light sources and/or detector. This is so the temperature sensor can sense the temperature of the environment, e.g., person's tissue, close to the operative parts of the optical sensor.

The distance between the center of the light source furthest from the center of the detector and the center of the detector may be the same as or greater than the distance between the center of the temperature sensor and the center of the detector. The temperature sensor may be positioned in line with or within the one or more loops of light sources. The temperature sensor may be configured to monitor the temperature of the tissue of the person.

The use of a temperature sensor may allow the sensor to monitor for any increases in temperature of the tissue resulting from the use of the sensor. In particular, the temperature sensor may allow the prevention of overheating of either the optical sensor or the tissue of the person. In the event that the temperature of the tissue of the person and/or the optical sensor increases beyond a tolerance, e.g., beyond 40° C., the optical sensor, e.g., processor, may be configured to issue an alert. Additionally or alternatively, the processor may be configured to deactivate the optical sensor.

The temperature sensor may also be used to ascertain whether the tissue is a suitable temperature for accurate physiological signs readings to be obtained using the optical sensor. For example, if the tissue is too cold, accurate readings of the one or more physiological signs may not be possible with the optical sensor. The optical sensor, e.g., processor, may be arranged so that if the measured temperature is below a certain temperature (e.g., below 35° C.) when the physiological signs are being monitored, an alert is issued and/or the optical sensor is deactivated.

The temperature sensor may also be used to check that the sensor is in close enough proximity to a person for physiological sign readings to be taken. This is because if the temperature detected is different to that expected of a person's skin it may be inferred that the first surface of the optical sensor is not in close enough proximity to the person's skin for accurate readings to be taken. The optical sensor, e.g., processor, may be arranged so that if the measured temperature is outside a predetermined range (e.g., outside a range of 35 to 40° C.) when the optical sensor physiological signs are being monitored, an alert is issued and/or the optical sensor is deactivated.

The presence of the temperature sensor means that in use, the sensor may be arranged to output a measurement of the temperature.

The optical sensor may comprise a transparent surface that covers the detector and the plurality of light sources. The surface may be transparent to all of the wavelengths that can be emitted by the light sources. The optical sensor and transparent surface may be configured such that the transparent surface contacts the tissue of the person during use. The transparent surface may be a flat surface. The transparent surface may be present to protect the detector and light sources from damage and/or dirt. The transparent surface may be easily cleaned after use of the optical sensor.

The optical sensor may be part of a medical device for measuring of one or more physiological signs. Alternatively, the optical sensor may be part of a consumer wearable device such as a sports watch.

The optical sensor may be for attaching to a person's skin, such as their neck. In other words, the optical sensor may be configured for attachment to a person's skin. The optical sensor may be used outside of the body of the patient, i.e., in contact with the outer surface of their skin. This facilitates attaching and detaching of the device from the person and allows the device to be visible during use. This is advantageous as it is easy for a health care worker to attach the device in a manner that can be easily viewed without needing constant attention. Furthermore, the neck may allow accurate measurements for the one or more physiological signs to be made.

As an alternative, the optical sensor may be for attaching to a person's wrist. This can allow the person themselves to easily view their own physiological signs. The optical sensor may be configured to attach to a person using an adhesive patch. The adhesive patch may comprise medical tape. The adhesive patch may comprise a base part to which the optical sensor can be clipped and unclipped. Alternatively, or in combination with the adhesive patch, the optical sensor may be configured to attach to a person using a strap.

The first aspect has been discussed above in terms of its use in measuring one or more physiological signs in a person. However, it will be appreciated that this use may form a separate aspect of the invention. In particular, according to a second aspect, there is provided a method of measuring one or more physiological signs in a person using the optical sensor according to the first aspect above. Moreover, according to a third aspect, there is provided a physiological signs measuring device comprising an optical sensor according to the first aspect.

The second and third aspects of the invention may comprise any of the features described in relation to the first aspect above.

The method may comprise attaching the optical sensor to a person, e.g., the skin of a person. This may be so that the first surface of the optical sensor faces and/or is in close proximity to the skin of the person. The method may comprise emitting light at one or more wavelengths of light using one or more of the plurality of light sources. The method may comprise emitting light of different wavelengths at different times. The method may comprise using the detector to record signals in correspondence to the emitted light. The method may comprise determining the one or more physiological signs using the sensor, e.g., the processor of the sensor, and/or outputting an indication of the one or more physiological signs.

When an optical sensor, such as that described in the first aspect above, comprises a detector and is configured to emit a plurality of different wavelengths it may be beneficial to check the functionality of the optical sensor before it is used to monitor one or more physiological signs. Such a process may be referred to as initialising the optical sensor for use.

Viewed from a fourth aspect, there is provided a method of initialising an optical sensor for measuring one or more physiological signs, the sensor comprising a detector and one more light sources, the method comprising the following steps before the device is attached to a person: emitting one or more light pulses (e.g., sequentially) at one or more different wavelengths using the one or more light sources, wherein each light pulse is emitted at a known power level for a known length of time; recording the signal for the one or more light pulses at each wavelength (e.g., sequentially) using the one or more detectors; determining a parameter for each signal at each wavelength of light; comparing the determined parameter to a stored value of the parameter for each wavelength; and determining that the optical sensor is ready for use if the determined parameter for each wavelength is within a set tolerance of the stored value of the parameter for each wavelength.

This method may be referred to as an initialisation method.

The optical sensor may be as described in the first aspect above. Thus the method may be performed using the optical sensor described above, optionally including one or more or all of the optional features. Alternatively, the method may be performed using other known optical sensors, e.g., a known PPG sensor. This may for example be an optical sensor in which there are not a plurality of light sources that surround the detector. The method may be performed using any known optical sensor for measuring one or more physiological signs that comprises a detector and one more light sources.

The method may be performed before use of the optical sensor to monitor one or more physiological signs, i.e., before the optical sensor is attached to the skin of a person. The method of initialising the optical sensor may be regarded and/or referred to as a method of checking that the optical sensor is working optimally and/or to a sufficient level before the optical sensor is used to monitor one or more physiological signs. The method may be performed during manufacture of the optical sensor, and/or or by a consumer directly prior to its first use and/or before each use of the optical sensor on a person.

The method may comprise a step of recording the signal received using the detector when no light is being emitted by the one or more light sources. This step may be performed prior to emitting the light pulses. Thus the method may comprise first switching on the detector such that it is in a state to receive light with a given integration time and then recording background signal before the light sources are switched on. This may allow the sensor to monitor the background signal in absence of any input from the one or more light sources of the optical sensor. This may be used to check that the detector is working sufficiently and/or that the background noise is within an acceptable level for the recorded signals to be meaningful.

The method described in the fourth aspect above may ensure that the optical sensor, detector and/or each of the plurality of the one or more light sources are working correctly and/or in accordance with manufacturer's standards. This may improve the reliability of the physiological signs monitored using the optical sensor. This is because it may be ensured that the optical sensor is working correctly before it is used on a person.

The parameter may be or comprise any quantifiable parameter related to the recorded signal for each wavelength. Furthermore, the parameter may be easily measurable or easily derivable, quantifiable parameter. For example, the parameter may be one of irradiance, intensity or the square of intensity. The intensity and square of intensity may be a reflected intensity of the signal for each wavelength of light.

The parameter may be or comprise the signal to noise ratio for each signal at each wavelength of light. Each wavelength of light may therefore comprise a stored signal to noise ratio which may be used in the comparison step of the method.

The signal to noise ratio may be the ratio of the signal power (i.e., power of the emitted light pulses) to the noise power (i.e., power of detected signal).

The signal-to-noise ratio may be determined using a standard methodology such as the one described in “Signal-to-noise ratio as a quantitative measure for optical biosensors” (https://www.maximintegrated.com/en/design/technical-documents/app-notes/6/6410.html).

For instance, the signal-to-noise ratio may be determined by comparing the amplitude of the pulsating signal recorded for each wavelength to the noise floor of the device. The method may comprise recording a background signal for each wavelength by using the one or more detectors prior to emitting the light pulses at one or more different wavelengths. The noise floor used in the step of determining the signal-to-noise ratio for each wavelength may be the total signal recorded by the detector.

Alternatively, the signal-to-noise ratio for each of the plurality of wavelengths may be determined by comparing the intensity and/or variation amplitude of the light pulse emitted from the light source to the intensity and/or variation amplitude of the light pulse recorded by the detector. The intensity may comprise the power level of the signal. The variation amplitude may comprise the pulsating signal corresponding to the emitted or detected light source.

The stored value of the parameter for each wavelength may depend on the properties of the optical sensor. In particular, the stored value of the parameter may be input and/or set by the manufacturer of the optical sensor. For example, the manufacturer of the optical sensor may determine the values for the parameter to be used in the initialisation method. The initialisation method may then be used to confirm that the optical sensor is operating as expected based on the set-up by the manufacturer.

The stored value of the parameter may be stored within a look-up table. The look-up table may be stored on the optical sensor. The stored data may be stored on the optical sensor such as within a memory that may be accessible by the processor, which may be housed within the optical sensor. The stored values of the parameter, e.g., signal to noise ratios, may be bespoke for each optical sensor produced. The stored values of the parameter may be stored to be accessible by the processor for each optical sensor accordingly. The stored value of the parameter for each wavelength may be determined during manufacture of the optical sensor, e.g., within the factory. This may be achieved by performing tests on the produced optical sensor. This may be before the optical sensor is supplied to a consumer for use. The stored values of the parameter, e.g., signal to noise ratios, may be determined when the optical sensor is known to be working optimally, e.g., immediately after manufacture and/or in controlled conditions. Thus the comparison between the determined parameters, e.g., determined signal to noise ratios, and the stored values of the parameter, e.g., stored signal to noise ratios, may be used to check that the optical sensor is working optimally or sufficiently near optimally.

The determined parameters and the stored values of the parameter may be ascertained under the same conditions. This is so that a like-for-like comparison may be made.

The known power level and known length of time that each light pulse of each wavelength is emitted at may be the same as the power level and length of time of light pulses that was used when determining the stored values of the parameter. This is so a like-for-like comparison may be made between the determined parameter and the stored values of the parameter for each wavelength.

The method may comprise indicating that the optical sensor is ready for use. This may occur if it is determined that the optical sensor is ready for use, e.g., if the parameter for each wavelength is within a set tolerance of the stored value of the parameter for each wavelength. This indication may be via a notification to the user and may be an audible and/or visual alert. The step of indicating that the optical sensor is ready for use may occur after the step of determining that the optical sensor is ready for use (i.e., working optimally or sufficiently close to optimally to be used (i.e., within the set tolerance)).

The method may comprise determining that the optical sensor is not ready for use if the determined parameter for one or more of the wavelengths is outside a set tolerance of the stored value of the parameter for the respective wavelength.

If it is determined that the parameter for one or more of the wavelengths is outside a set tolerance of the stored value of the parameter for the respective wavelengths, the method may comprise repeating one or more times the steps of emitting one or more light pulses (e.g., sequentially) at a one or more different wavelengths using the one or more light sources, recording the signal for the light pulses at each wavelength (e.g., sequentially) using the one or more detectors; determining a parameter for each signal at each wavelength of light; and comparing the determined parameter to a stored value of the parameter for each wavelength.

The method may comprise indicating that the optical sensor is not ready for use if the parameter for one or more wavelength is outside of a set tolerance of the stored value of the parameter for the respective wavelengths. The method may comprise indicating that the optical sensor is not ready for use if it is determined that the optical sensor is not ready for use.

The step of indicating that the optical sensor is not ready for use may comprise indicating that the sensor is defective. In this case the initialisation method may be performed again (e.g., as instructed by the user) and/or the sensor may be serviced.

If the parameter for one or more wavelengths is outside of a set tolerance of the stored value of the parameter for each wavelength, the method may be repeated a predetermined number of iterations after which the method may comprise indicating that the optical sensor is not ready for use. The predetermined number of iterations may be defined by the manufacturer of the optical sensor. The predetermined number of iterations may be for example, 2, 5, or 10. In this case, the method may not be continuously repeated if there is a detected inherent error or malfunction within the sensor, e.g., if it is determined that the detector is not picking up signals correctly. Instead, it may simply be determined and/or indicated that the optical sensor is not ready for use.

If it is determined that the optical sensor is not ready for use, the method may comprise indicating that maintenance is required. The method may comprise indicating that the optical sensor is malfunctioning and/or faulty. This indication may be a notification to the user and may be an audible and/or visual alert. In this instance, the optical sensor may need to be returned to the manufacturer or some other expert for repair. This step may be beneficial as it can prevent a malfunctioning optical sensor being used to monitor physiological signs.

The set tolerance may be up to ±5%, optionally ±2%. In other words, in order for it to be determined that the optical sensor is ready for use, the determined parameter should be within +5%, or optionally ±2%, of the stored value of the parameter for each wavelength. The set tolerance may be the same for each wavelength and/or or each light source of the one or more light sources. Alternatively, the set tolerance may be different for each wavelength and/or light source. For instance, a light source which is configured to emit light with a longer wavelength may have a greater set tolerance than a light source which is configured to emit light at a shorter wavelength, or vice versa.

The initialisation method may be performed under certain defined conditions. The initialisation method may be performed when the optical sensor is facing a reflective surface with certain reflective properties, e.g., a reflectance target with known properties. The reflective surface may be a standardized reflective surface such as a white and/or grey surface. For example the steps of emitting light pulses at a plurality of different wavelength using the one or more light sources, and recording the signal for the light pulses at each wavelength using the detector may be performed when the detector and one or more light sources is facing a particular reflective surface, e.g., a reflective surface with certain known reflective properties. The stored values of the parameter may be determined when the detector and one or more light sources is facing the same reflective surface or a reflective surface with the same reflective properties. This may ensure that there can be a like-for-like comparison between the determined parameter and the stored value of the parameter for each wavelength. The particular reflective surface may be provided for example by a reflective cover that can be fitted over the optical sensor. The reflective cover may comprise a reflective film or reflective cap. The reflective cover may comprise any type of reflective material. The reflective cover may be a sticker that can been peeled off the sensor after the initialisation method has been performed, e.g., peeled off just before the optical sensor is put on the person's skin.

Additionally, or alternatively the sensor may be provided with a storage case, e.g., box, and the sensor may face the particular reflective surface when housed within the storage case.

The initialisation method may comprise facing the detector and one or more light sources towards a particular reflective surface. This may for example comprise covering the detector and one or more light sources with a reflective cover and/or housing the optical sensor within a storage case. The step of facing the detector and one or more light sources may be performed before the steps of emitting light pulses at a plurality of different wavelength using the one or more light sources, and recording the signal for the light pulses at each wavelength using the detector.

This may be beneficial as it means that the determination of the parameter may be performed under known conditions and that these may be the same conditions under which the stored value of the parameter is determined.

The term “sequentially” herein should be interpreted such that the light pulses of each wavelength are emitted at different times to each other, e.g., one after the other, and/or recording a signal for each wavelength occurs at different times. In the case where multiple light sources are configured to emit light pulses of the same wavelength the method may comprise emitting each of the light pulses of the same wavelength from different light sources simultaneously. For example, in the case of the one or more light sources comprising two light sources both configured to emit infrared light of the same wavelength, the method may comprise both of these infrared light sources emitting their respective light pulses at the same time.

Alternatively, in the case where multiple light sources are configured to emit light pulses of the same wavelength the method may comprise emitting each of the light pulses of the same wavelength sequentially, i.e., at different times. For example, in the case of the one or more light sources comprises two light sources both configured to emit infrared light or the same wavelength, the method may comprise both infrared light sources emitting their respective light pulses one after the other. This may allow each of the light sources to be checked individually.

The detection of the light pulses by the one or more detectors may be time multiplexed according to the emission of each wavelength. This is so it can be accurately determined which wavelength of light caused the detected signal.

The optical sensor may comprise one or more broadband light sources. The optical sensor may comprise one or more wavelength sensitive detectors, and/or one or more detectors provided with optical filters so that recording a signal for each wavelength can be achieved, even with a broadband light source.

The present invention also extends to an optical sensor which is configured to perform the method described in the fourth aspect above.

Accordingly, viewed from a fifth aspect, there is provided an optical sensor for measuring one or more physiological signs, the sensor comprising one or more detectors and one or more light sources, wherein prior to the device being attached to a person, the optical sensor is arranged to perform the method of the fourth aspect. In other words the optical sensor may be configured to emit one or more light pulses (e.g., sequentially, i.e., at different times) at one or more different wavelengths using the one or more light sources, wherein each light pulse is emitted at a known power level for a known length of time; record the signal for the one or more light pulses at each wavelength (e.g., sequentially) using the one or more detectors; determine a parameter for each signal at each wavelength of light; compare the determined parameter to a stored value of the parameter for each wavelength; and determine that the optical sensor is ready for use if the determined parameter for each wavelength is within a set tolerance of the stored value of the parameter for each wavelength.

The optical sensor may comprise a processor. The optical sensor and/or processor may be configured to carry out any of the steps of the fourth aspect above, including one or more or all of the optional features.

It has been realized that another way to improve the accuracy and reliability of an optical sensor for measuring one or more physiological signs is to perform one or more calibration methods once the sensor has been attached to a person. The calibration methods may involve one or more adjustments to the operation of the sensor based on how the light detected by the detector is affected by the particular conditions created by the attachment to a particular person's skin. Thus methods that involve calibrating the sensor for use with different people and/or various skin profiles may be provided.

Viewed from a sixth aspect, there is provided a method of calibrating an optical sensor for measuring one or more physiological signs of a person, the sensor comprising one or more detectors and one or more light sources, the method comprising the following steps after the device is attached to the person: emitting one or more light pulses at one or more different wavelengths, e.g., in sequence (i.e., at different times), using one or more of the one or more light sources, wherein each light pulse at each wavelength is emitted at a known power level and for a known length time; recording a signal for the one or more light pluses at each wavelength using the one or more detectors; determining a parameter for each signal at each wavelength of light; comparing the determined parameter to a stored value of the parameter or each wavelength of light; and adjusting the power and/or length of time of the light pulse(s) at each wavelength to reduce the difference between the determined parameter and the stored value of the parameter.

The optical sensor may be as described in the first aspect above. Thus, the calibration method may be performed using the optical sensor of the first aspect (optionally including one or more or all of the optical features). Alternatively, the calibration method may be performed using any other known type of optical sensor for measuring the physiological signs of a person (i.e., one in which the light sources do not surround the detector). Such an optical sensor may comprise one or more detectors and one or more light sources.

Furthermore, the optical sensor may have been initialized according to the method described in the fourth aspect of the invention. Thus, the calibration method may be performed after the initialisation method of the fourth aspect. It may be that the optical sensor was determined to be ready for use in accordance with the fourth aspect.

Alternatively, the calibration method may be performed even if the initialisation method is not performed.

The method above may be able to calibrate the sensor for the specific person to be monitored. This is because the method may calibrate the sensor for the specific skin profile of the person. This calibration may be achieved by adjusting and/or optimizing the optical sensor, i.e., power and/or length of time of the light pulse(s) for each wavelength, depending on how the detected signals are affected when attached to a person. This may be to improve the signal quality that is achievable for each wavelength for a given person/skin profile.

The calibration method may be performed before the optical sensor is used to monitor one or more physiological signs of the person. Additionally, or alternatively, the calibration method may be performed during the measuring of one or more physiological signs. For example, after using the optical sensor to monitor one or more physiological signs for a period of time, e.g., for 5 minutes, the calibration method may be performed. This may be a repeat of the calibration method that was performed before the one or more physiological signs were started to be monitored. This may allow it to be ensured that the optical sensor is calibrated over the entire period of use of the sensor, e.g., to accommodate for adjustments or drift of any of the components of the sensor over time.

The term “skin profile” should be understood to comprise multiple parameters related to various skin properties such as blood content, skin thickness, amount of subcutaneous fat, skin pigmentation, scattering from connective tissue etc. . . . . The skin profile may depend on factors such as skin tone/color, skin condition and/or skin/tissue make up. The skin condition may for example be affected by the age of the person. For instance, an older person may have skin condition that is different to a younger person and the older person's skin may cause more scattering of the light. Furthermore, the skin condition may be affected by the life-style of the person, e.g., how much sunlight the skin has been exposed to over the lifetime of the person. The skin/tissue make up, e.g., fat and water levels, may also affect the way in which the light is reflected and transmitted through the person's skin. By utilizing the above method of calibration, the optical sensor may provide more accurate measurements for most if not all different people, regardless of factors such as skin tone/color, skin condition and/or skin/tissue make up. Each person may have a unique skin profile.

The optical sensor may comprise a single detector and a single light source. The detector may be able to detect a plurality of different wavelengths. The light source may be able to emit a plurality of distinct wavelengths of light.

In the most basic case (e.g., when the physiological sign to be monitored can be done so using a single wavelength of light), the method may comprise emitting a single light pulse at a single wavelength using a single light source at a known power level and for a known length time. Such a case may be performed even if the optical sensor is capable of emitting multiple wavelengths of light and/or has multiple light sources.

The one or more physiological signs may include one or more vital signs such as blood oxygen saturation, pulse rate and respiration rate. The person may be a patient.

The detector may be a photo detector. Alternatively, the detector may be a camera. The camera may comprise one or more individual pixels.

The calibration method does not necessarily have to be performed for every wavelength that can be emitted by the sensor and/or for every light source. This may for example, be because not all of the wavelengths that can be emitted or not all of light sources are going to be used to monitor the physiological signs of the particular person concerned.

The method may comprise emitting light pulses at a plurality of different wavelengths. This may be of particular use when the physiological signs to be monitored require the use of two or more different wavelengths and so the ability to emit and calibrate the sensor for a plurality of wavelengths of light could be beneficial. Even in this case, the plurality of wavelengths may be a subset of the total number of discrete wavelengths that can be emitted by the sensor.

The stored parameter for each wavelength may be a parameter recorded before the optical sensor is attached to the person. This may be a parameter, e.g., signal to noise ratio, recorded during a set up (e.g., initialisation method) shortly (e.g., within minutes or hours) before the optical sensor is attached to the person or at some other point, e.g., before the optical sensor is supplied to the user, e.g., during manufacture. The stored value of the parameter for each wavelength may be a parameter determined under set controlled conditions, e.g., at a given intensity and when the sensor faces a reflectance target with known properties. The stored value of the parameter for each wavelength may be the parameter determined in the method described in the fourth aspect above. In other words, the stored value of the parameter, e.g., signal-to-noise ratio for each wavelength may be the parameter determined during the initialisation of the optical sensor. Thus the stored value of the parameter may be different each time the optical sensor is calibrated.

Alternatively, the stored value of the parameter for each wavelength may be a set predetermined parameter. This may for example, be defined by the manufacturers. The predetermined parameter may depend on the properties of each of the one or more light sources and/or measurements taken before the optical unit is supplied to a user, e.g., by the manufacturer. Thus, the stored value of the parameter could remain the same each time the optical sensor is calibrated. In other words, the stored parameter, such as the stored signal to noise ratio for each wavelength, may be an expected value for the recorded signal in ideal conditions.

The known power level and/or known length of time for each light pulse may be a default power level and/or default length of time. The known power level and/or known length of time for each light pulse may be the same each time the calibration method is performed. The known/default power level and/or known/default length of time may be an initial power level and/or initial length of time. The known power level and/or known length of time may be average values. The average values may be determined by the manufacturer, e.g., based on a database.

The known power level and/or known length of time for each light pulse may be a mid-power level and/or mid length of time. This may mean that the power level and/or length of time may be both increased and decreased from the known/default values.

The known power level and known length of time may be average values across all expected skin profiles.

The step of adjusting the power and/or time of the light pulses at each wavelength may comprise increasing or decreasing one or more of the power and/or time. For example, the method may comprise increasing the power of the light pulse and reducing the time of the light pulse. As a further example, the method may comprise increasing the power of the light pulse and increasing the time of the light pulse, or decreasing the power of the light pulse and decreasing the time of the light pulse, or decreasing the power of the light pulse and increasing the time of the light pulse.

As will therefore be appreciated, the optical sensor may be arranged such that both the power of the light pulse and the time of the light pulse can be adjusted. However, even when the optical sensor is arranged such that both the power of the light pulse and the time of the light pulse can be adjusted, the method may comprise only adjusting one of power of the light pulse or the time of the light pulse, or both.

In other words, the optical sensor may be arranged such that the power of the light pulse and the time of the light pulse are separate tunable parameters for each of the one or more wavelengths. This may provide greater adjustability and precision when calibrating the optical sensor to reduce the difference between the determined parameter and the stored value of the parameter.

The step of adjusting the power and/or time of the light pulses at each wavelength may include choosing to adjust one or both of the power and time of the light pulses for each wavelength. This step of choosing to adjust one or both of the power and time of the light pulses for each wavelength may be based on one or more of the recorded signals for the one or more light pulses at each wavelength and the comparison between the determined parameter for each signal at each wavelength with a stored value of the parameter at each wavelength.

Accordingly, it will be appreciated that in some instances, it may only be necessary for the power of the light pulse to be adjusted, and in other instances it may only be necessary for the time of the light pulse to be adjusted, or it may be necessary for both the power of the light pulse and the time of the light pulse to be adjusted. It is therefore beneficial for the optical sensor to be configured such that it is possible to adjust both the power and time of the light pulse, so that the calibration method can then be decided accordingly. The method may comprise determining whether to adjust the power of the light pulse or the time of the light pulse, or both.

The adjustment of the power and/or length of time of each of the one or more light pulses may be used to adjust the light dose provided by each of the one or more light pulses.

The term light dose may be understood as the total energy of the light absorbed by the tissue for a given light pulse. In other words, the light dose may be the product of the power of the light pulse absorbed by the tissue and the length of time the light pulse for which the light pulse is absorbed by the tissue. The same light dose may therefore be achieved by increasing the power of the light source and decreasing the length of time that the light source is emitting for, or vice versa. For example, it may be possible to have the same light dose by increasing the power whilst keeping the length of time the light pulse is emitted for constant, or only increasing the length of time for which the light pulse is emitted, whilst keeping the power of the light pulse constant.

The method may comprise adjusting only one of the power and/or time of the light pulse. In particular, the method may comprise increasing or decreasing only one of the power and/or time of the light pulse for each wavelength.

The method may comprise adjusting the power and/or time of the light pulse of each wavelength in the same manner. For example, both the power and time of the light pulse of each wavelength may be increased for each wavelength. Alternatively, the method may comprise adjusting the power and/or time of the light of each wavelength in a different manner, i.e., independently. In other words, one of the power and/or length of time of the light pulse may be increased, and the other of the power and/or time may be decreased. In particular, for some wavelengths the power and time of the light pulse may be increased, meanwhile for other wavelengths the power may be increased and the time may be decreased. This may depend on the difference between the determined parameter and the stored value of the parameter for each wavelength. For example, it may be that for certain longer wavelengths a higher power and/or longer time is required to reduce the difference, while for shorter wavelengths a lower power and/or shorter time is required to reduce the difference.

For lighter skin tones, it may be necessary to decrease the power level and/or length of time of the emitted light pulse(s). Conversely, for darker skin tones, it may be necessary to increase the power level and/or length of time of emitted light pulse(s).

The parameter for each of the plurality of wavelengths may be determined by a processor within the optical sensor.

The parameter may be any quantifiable parameter related to the recorded signal for each wavelength. Furthermore, the parameter may be easily measurable or easily derivable, quantifiable parameter. For example, the parameter may be one of irradiance, intensity or the square of intensity. The intensity and square of intensity may be a reflected intensity of the signal for each wavelength of light.

In a preferred arrangement, the parameter may be the signal to noise ratio for each signal at each wavelength of light. Each wavelength of light may therefore comprise a stored signal to noise ratio which may be used in the comparison step of the method.

The signal to noise ratio may be the ratio of the signal power (i.e., power of the emitted light pulses) to the noise power (i.e., power of detected signal).

The signal-to-noise ratio may be determined using a standard methodology. One example is described in “Signal-to-noise ratio as a quantitative measure for optical biosensors” (https://www.maximintegrated.com/en/design/technical-documents/app-notes/6/6410.html).

The signal-to-noise ratio may be determined by comparing the amplitude of the pulsating signal recorded for each wavelength to the noise floor of the device. The method may comprise recording a background signal for each wavelength by using the one or more detectors prior to emitting the light pulses at one or more different wavelengths. The noise floor used in the step of determining the signal-to-noise ratio for each wavelength may be the total signal recorded by the detector.

Alternatively, the signal-to-noise ratio for each of the plurality of wavelengths may be determined by comparing the intensity and/or variation amplitude of the light pulse emitted from the light source to the intensity and/or variation amplitude of the light pulse recorded by the detector. The intensity may comprise the power level of the signal. The variation amplitude may comprise the pulsating signal corresponding to the emitted or detected light source.

The method may comprise attaching the optical sensor to the skin of the person. The optical sensor may be attached such that the one or more detectors and one more light sources are facing the surface of the skin of the person. As such, the light pulses emitted by the plurality of light sources may be directed into the tissue of the person. The optical sensor may be a reflectance sensor (e.g., a reflectance pulse oximeter), in which case the one or more detectors and one more light sources may be configured such that in use they are located on/face the same surface of the tissue of the person.

Alternatively, the optical sensor may be a transmissive sensor in which case the one or more detectors and one more light sources may be configured such that in use they are located on opposite sides of the tissue of the person. For example, the one or more light sources may be located on one side of a person's fingertip, and the one or more detectors may be located on the other side of the person's fingertip.

The steps of the method may be carried out while the device is attached to the person for which the physiological signs are to be measured.

The method may comprise removing the optical sensor from an environment e.g., in which the initialisation method (if performed) was performed. For example, the method may comprise removing the sensor from a storage case and/or removing a cover. The optical sensor may be attached to the skin of a person by any known means, such tape, adhesive base and/or strap etc.

The method may comprise turning the sensor on (if this is not automatic when the sensor is attached to a person). The method may comprise the sensor indicating that it is on and/or performing a calibration method.

The term “in sequence” or “sequentially” should be interpreted such that the one or more light pulses of each wavelength, in the case of there being a plurality of wavelengths, are emitted at different times, e.g., one after the other and/or recording a signal for each wavelength occurs at different times. In the case where multiple light sources are configured to emit light pulses of the same wavelength the method may comprise emitting each of the light pulses of the same wavelength simultaneously. For example, in the case of the light sources comprising two light sources both configured to emit infrared light or the same wavelength, the method may comprise both infrared light sources emitting their respective light pulses at the same time.

Alternatively, in the case where multiple light sources are configured to emit light pulses of the same wavelength the method may comprise emitting each of the light pulses of the same wavelength sequentially. For example, in the case of the one or more light sources comprising two light sources both for emitting infrared light at the same wavelength, the method may comprise both infrared light sources emitting their respective light pulses one after the other.

The method may comprise determining a difference between a determined parameter to the stored value of the parameter for each wavelength of light. The method may comprise comparing the difference between a determined parameter to the stored value of the parameter for each wavelength of light to a predetermined tolerance. The method may comprise adjusting the power and/or time of the light pulses at each wavelength to reduce the difference to be within the predetermined tolerance.

The predetermined tolerance may be up to ±20% of the stored parameter, optionally up to ±15%, optionally up to ±10%, optionally up to ±5%, optionally up to ±2% of the stored value of the parameter. The tolerance may be the same or different for different light sources and/or wavelengths.

Following the step of adjusting the power and/or time of the one or more light pulses at each wavelength, the method may comprise repeating one or more times the steps of emitting one or more light pulses at a one or more different wavelengths using the one or more light sources (although in this case at the adjusted power and/or length of time), recording the signal for the light pulses at each wavelength using the detector; determining a parameter for each signal at each wavelength of light; and comparing the determined parameter to the stored value of the parameter for each wavelength. The repeated steps may comprise emitting the one or more light pulses at an adjusted power level for an adjusted length of time, i.e., the power level and length of time resulting from the last adjustment step of the last repeat of the method. The method may be repeated until the difference between the determined parameter and stored value of the parameter for each wavelength of light is within a predetermined tolerance and/or as small a possible within a given number of repetitions or within a given length of time. The method may be repeated up to a certain number of times, e.g., up to 100 times. If the difference between the determined parameter and stored value of the parameter for each wavelength of light is not within a predetermined tolerance within a certain number of iterations, e.g., within 100 repeats, of the method, the optical sensor may be arranged to indicate, e.g., audibly and/or visually, that it is not suitable for use. This may prevent an optical sensor that would not give sufficiently accurate readings from being used.

In operation, the difference between the determined parameter and the stored value of the parameter for one or more of the plurality of wavelengths may be within a predetermined tolerance, while the difference between determined parameter and the stored value of the parameter for the remaining wavelengths of the plurality of wavelengths may be outside a predetermined tolerance.

For example, in the case of the plurality of different wavelengths comprising eight different wavelengths, the difference between the determined parameter and the stored value of the parameter for five of the different wavelengths may be within the predetermined tolerance, and for the other three different wavelengths the difference between the determined parameter and the stored value of the parameter may be outside the predetermined tolerance. In this case, the method may comprise adjusting the power and/or time of the light pulse only for the wavelengths where the difference between the determined parameter and the stored value of the parameter for one or more of the plurality of wavelengths may be within a predetermined tolerance. Alternatively, in this instance the method may still comprise adjusting the power and/or time adjusting the power and/or time of the light pulse for each of the plurality of wavelengths in order to further reduce the difference between the determined parameter and the stored value of the parameter.

In the case that the difference between the determined parameter and the stored value of the parameter for one or more of the plurality of wavelengths is within a predetermined tolerance, while the difference between determined parameter and the stored value of the parameter for the remaining wavelengths of the plurality of wavelengths is outside a predetermined tolerance, the method may comprise measuring the physiological signs of the person only using one or more of the wavelengths of light for which the difference between the determined parameter and the stored value of the parameter for one or more of the plurality of wavelengths is within a predetermined tolerance.

The method may comprise indicating that the optical sensor is calibrated and/or ready for use once the difference between the determined parameter and the stored value of the parameter for each wavelength is within a predetermined tolerance. The method may comprise indicating that the optical sensor is calibrated and/or ready for use once the difference between the determined parameter and the stored value of the parameter for sufficient wavelengths to be able to monitor one or more physiological signs is within a predetermined tolerance. The indication may comprise an audible and/or visual alert.

The method may be re-iterated periodically during use, e.g., every 5 minutes. One reason for this may be because bodily fluids, such as sweat, may accumulate on the surface of the one or more detector or the light sources which may cause a change in the parameter, e.g., the signal to noise ratio. This is a particular consideration in the case where the optical sensor may be a wearable device such as a sports watch. As such, the optical sensor may be re-calibrated accordingly to account for any obstructions on the surfaces of the sensor. If when the method is re-iterated it is found that the difference between the determined parameter and the stored value of the parameter has increased such that it may be outside the predetermined tolerance, the method may comprise providing an alert. This may trigger the user to clean the surfaces of the optical sensor. The method may then be re-iterated again to determine if the difference between the determined parameter and the stored value of the parameter is within the predetermined tolerance.

The method may comprise recording a signal for the one or more light pluses at each wavelength using the one or more detectors to create an optical signature for the person.

The optical signature of the person may be the signals recorded for each wavelength in the initial recording of the signal using the known/initial power and/or known/initial time for each wavelength of the plurality of wavelengths. In other words, the optical signature of the person may be based on the light pulse prior to any adjusting of the power and/or time of the light pulses. The optical signature may comprise a signal for each of the plurality of wavelengths. The optical signature of the person may give an indication of how each emitted wavelength at a standard power and length of time is affected by that person's particular skin profile. This may give an indication of a particular person's skin type.

The method may comprise storing the optical signature of the person.

The optical signature of the person may be compared to a library of stored optical signatures in order to select one or more wavelengths to be used when measuring the one or more physiological signs.

The library of optical signatures may be organized into a plurality of skin profile categories. Each skin profile category may comprise a predetermined one or more wavelengths to be used when measuring the one or more physiological signs. The step of comparing the optical signature of the person to the library may include assigning a skin profile category to the person and selecting the one or more wavelengths to be used when measuring the one or more physiological signs based on the assigned skin profile category.

The assigned skin profile category may be category/class of skin types that the particular skin type of the person falls within or most closely aligns with. For example, the library of optical signatures may comprise three skin profile categories, which may be regarded broadly as dark, medium and light skin. The recorded optical signature of the person may be analyzed to determine with which skin profile category the person's skin falls within or most closely aligns with, i.e., that with which the light is affected in the same or most similar way. This may be for example be an assessment of how much scattering and/or absorption of light occurs for each wavelength of light. The optical signature of the person may be assigned to a specific skin profile category from the library. The skin profile category that the given optical signature is assigned to may be based on historical data. The historical data may have been collected by the individual optical sensor, or the historical data may be collected by many different optical sensors and collated in a central database. A given optical signature may be identified as falling within a given skin profile category.

The library of optical signatures may be stored for access by a processor. The library may be stored on memory within the optical sensor, or on a separate device which may be in wireless or wired communication with the optical sensor.

Each skin profile category may have a predetermined one or more wavelengths of the plurality of wavelengths that are to be used when measuring the physiological signs of a person with a skin type falling within said skin profile category.

The method may be able to estimate specific skin properties of the person according to their optical signature and/or assigned skin profile category.

Based on the optical signature, assigned skin profile category and/or estimated skin properties a suitable selection or combination of one or more wavelengths may be selected for measuring the one or more physiological signs. The suitable selection or combination of wavelengths to be used may be one or more wavelengths that would give sufficiently accurate and/or reliable readings of the one or more physiological signs for that particular optical signature and/or skin profile category.

The selection of one or more wavelengths to be used when measuring the one or more physiological signs may be determined using a look up table, a model using machine learning algorithms, based on light transport simulations and/or any other suitable method.

The one or more wavelengths once selected may be emitted using the adjusted values of power level and/or length of time (i.e., those which reduce or minimize the difference between the determined parameter and a stored value of the parameter to at least within a predetermined tolerance) when measuring the one or more physiological signs.

The method may allow the optical sensor to record an initial optical signature of the person of a given skin type without any calibration.

The method may further comprise selecting one or more wavelengths of the plurality of wavelengths based on the optical signature or assigned skin profile category of the person, wherein the selected one or more wavelength is to be used when measuring the one or more physiological signs. The one or more wavelengths selected may be the optimum wavelength(s) for measuring the assigned skin profile category of the person, i.e., those expected to give the most accurate and/or reliable readings for the one or more physiological signs being monitored. The one or more wavelengths may be selected based on historical data from measuring the physiological signs of people of the assigned skin profile. For instance, it may be found that for skin profile category A, a combination of green and infrared light is the optimum combination of wavelengths based on the data stored within the library of skin profiles.

The steps of creating an optical signature of the person, and selecting one or more wavelengths of the plurality of wavelengths based on the optical signature of the person to be used when measuring the one or more physiological signs may be carried out prior to the steps of determining the parameter for each signal at each wavelength of light, comparing the determined parameter to a stored value of the parameter for each wavelength of light, and adjusting the power and/or time of the light pulses at each wavelength to reduce the difference between the determined parameter and the stored parameter. In other words, the steps of determining the parameter for each signal at each wavelength of light, comparing the determined parameter to a stored value of the parameter for each wavelength of light, and adjusting the power and/or time of the light pulses at each wavelength to reduce the difference between the determined parameter and the stored value of the parameter may only be carried out for the one or more selected wavelengths. In this case, the parameter, e.g., signal-to-noise ratio, may only be determined for the signals corresponding to the one or more wavelengths selected to be used when measuring the one or more physiological signs.

This may be beneficial as it may reduce the computational requirements and/or time of the calibration method by only determining the parameter and adjusting the power and/or time of the light pulses corresponding to the selected wavelengths, rather than for every wavelength that may be emitted by the optical sensor.

The library of optical signatures may be organized into a plurality of categories each comprising a plurality of different optical profiles. For example, the library of stored optical signatures may comprise 2-8 categories, wherein each category may comprise 2-6 optical signatures. Each category of optical signatures may have an assigned combination of one or more wavelengths which may form the basis for the selection in the method. This assigned combination of one or more wavelengths may be that which is regarded as optimum for that category.

The method may allow the most suitable wavelengths to be used when measuring the physiological signs. The historical database may comprise information on the optimum wavelengths for each optical signature or group of optical signatures.

The method of selecting wavelengths to use in the physiological sign measurements based on the skin profile, in combination with the step of adjusting the power and/or time of the light pulses of each wavelength to reduce the difference between the determined parameter and the stored value of the parameter may improve the accuracy and reliability of the measurements of the one or more physiological signs.

The number of wavelengths used in the measuring of the one or more physiological signs may depend on the physiological sign being monitored. It may not be necessary for every wavelength that the optical sensor can emit to be used when measuring the one or more physiological signs, and so the above method may be beneficial in selecting suitable wavelengths for a given skin or optical signature of the person when measuring the one or more physiological signs.

In the case of the physiological sign being breathing rate (i.e., respiration rate) or pulse rate, one wavelength may be sufficient to monitor the physiological sign. In this case, there may be a particular wavelength for a given skin type or optical signature that gives the most accurate and/or reliable reading. For example, for a person with a light skin tone selecting a shorter wavelength may give a more accurate result and for a person with a darker skin tone selecting a longer wavelength may give a more accurate result. The calibration method may give an assessment or indication of skin type, by means of the measured optical signature, that allows a selection of one or more wavelength to use to be made. It may also be the case, that even if it is possible to monitor a physiological sign using a single wavelength, signals from two or more different wavelengths may provide a more accurate and/or reliable reading. In the case of the physiological sign being blood oxygen saturation, two or more different wavelengths may be required. Similarly, there may be a particular combination of wavelengths for a given skin type/optical signature that gives the most accurate and/or reliable reading. The calibration method may give an assessment or indication of skin type that allows a selection of a combination of wavelengths to use to be made.

Once the calibration method has been performed (i.e., the power levels and/or emission length of time of one or more wavelengths has been adjusted and/or the one or more wavelengths to use has been selected), one or more physiological signed may be measured using the optical sensor. One the calibration method has been completed the sensor may indicate (e.g., visually and/or audibly) that the sensor is ready to measure one or more physiological signs of the person.

As with preceding aspects, the present invention also extends to an optical sensor which is configured to operate in accordance with the method described in the sixth aspect above. Thus the present invention may provide an optical sensor that is configured to perform the calibration method, including one or more or all of the optional features. This may or may not be the optical sensor of the first aspect.

The optical sensor may comprise one or more broadband light sources. The optical sensor may comprise one or more wavelength sensitive detectors, and/or one or more detectors provided with optical filters.

Accordingly, viewed from a seventh aspect, there is provided an optical sensor for measuring one or more physiological signs, the sensor comprising one or more detectors, and one or more light sources, wherein once the optical sensor is attached to a person, the optical sensor is configured to emit one or more light pulses at one or more different wavelengths using one or more of the one or more light sources, wherein each light pulse at each wavelength is emitted at a known power level and for a known length time; record a signal for the one or more light pluses at each wavelength using the one or more detectors; determine a parameter for each signal at each wavelength of light; compare the determined parameter to a stored value of the parameter for each wavelength of light; and adjust the power and/or time of the one or more light pulses at each wavelength to reduce the difference between the determined parameter and the stored value of the parameter.

The optical sensor may comprise a processor. The optical sensor and/or processor may be configured to carry out (or cause the execution of) any of the steps of the invention of the sixth aspect above, including one or more or all of the optional features.

The optical sensor may be a medical device, such as a pulse oximeter. The medical device may be for measuring one or more vital signs of a patient. Alternatively, the optical sensor may be a wearable device, such as a sports watch, for measuring one or more physiological signs of a person.

It should be appreciated that the calibration steps of creating an optical signature of the person; and selecting one or more wavelengths of the plurality of wavelengths based on the optical signature of the person to be used when measuring the one or more physiological signs, may be performed and beneficial even if the other steps of determining the parameter for each signal at each wavelength of light; comparing the determined parameter to a stored value of the parameter for each wavelength of light; and adjusting the power and/or time of the light pulses at each wavelength to reduce the difference between the determined parameter and the stored value of the parameter, are not performed.

Thus, viewed from a eighth aspect, there is provided a method of calibrating an optical sensor for measuring one or more physiological signs of a person after the device is attached to the person, the sensor comprising one or more detectors and one more light sources, the method comprising the following steps after the device is attached to the person: emitting one or more light pulses at one or more different wavelengths using one or more light sources, wherein each light pulse at each wavelength is emitted at a known power level and for a known length time; recording a signal for the one or more light pulses at each wavelength using one or more detectors to create an optical signature of the person; and selecting one or more wavelengths of the plurality of wavelengths based on the optical signature of the person to be used when measuring the one or more physiological signs.

The method of calibrating the optical sensor may comprise any of the steps or features, including one or more or all of the optional features, discussed in connection with the sixth aspect above. The calibration methods may be performed in parallel and not necessarily sequentially.

The method may comprise comparing the optical signature of the person to a library of stored optical signatures in order to select the one or more wavelengths to be used when measuring the one or more physiological signs. In this case, the step of selecting one or more wavelengths of the plurality of wavelengths to be used when measuring the one or more physiological signs may be based on the assigned skin profile.

The library of optical signatures may be organized into a plurality of skin profile categories. Each skin profile category may be associated with a predetermined one or more wavelengths to be used when measuring the one or more physiological signs. The step of comparing the optical signature of the person to the library may include assigning a skin profile category to the person and selecting the one or more wavelengths to be used when measuring the one or more physiological signs based on the assigned skin profile category.

The one or more wavelengths may be selected using a look up table, a model using machine learning algorithms, a light transport simulation and/or any other known method.

The method may comprise storing the optical signature of the person.

The optical signature may provide a spectral profile of the skin of the person on which the sensor is mounted. The optical signature may give an indication of the bulk properties of the person's skin/tissue in close proximity to the optical sensor, i.e., where the measurements are being taken.

The optical signature of the person may be compared to a library of stored optical signatures. This may be used to assign a skin profile category to the person.

The assigned skin profile category may be a category/class of skin types that the particular skin type of the person falls within or most closely aligns with. For example, the skin profiles may comprise three skin profile categories, A, B, and C which could for example be regarded broadly as dark, medium and light skin. The recorded optical signature of the person may be analyzed to determine with which skin profile categories the person's skin falls within or most closely aligns with, i.e., that with which the emitted light is affected in the same or most similar way. This may be for example be an assessment of how much scattering and/or absorption of light occurs for each wavelength of light when the optical sensor is affixed to the particular person. The optical signature of the person may be assigned to a specific skin profile category from the library.

Historical data for the library may have been collected by the individual optical sensor, or the historical data may be collected by many different optical sensors and collated in a central database.

The library may be stored for access by a processor. The library may be stored on memory within the optical sensor, or on a separate device which may be in wireless or wired communication with the optical sensor.

The method may comprise determining a skin profile category of a person. Each skin profile category within the library may have a predetermined one or more wavelengths of the plurality of wavelengths that are to be used when measuring the physiological signs of a person with a skin type/optical signature falling with said skin profile category.

The method may comprise using machine learning to create the library of stored optical signatures and skin profile categories and/or to select the one or more wavelengths to be used when measuring the one or more physiological signs. The skin profile category may be determined based on the intensity of the readings by the detector of a plurality or all of the wavelengths and/or by looking at one or more ratios of the readings of two or more of the wavelengths.

The method may be able to estimate the specific skin properties of the person according to their optical signature and/or assigned skin profile category. Based on the estimated skin properties a suitable selection or combination of one or more wavelengths may be selected for measuring the one or more physiological signs. The suitable selection or combination of wavelengths to be used may be one or more wavelengths that is known to give sufficiently accurate and/or reliable readings of the one or more physiological signs for that particular skin profile category. The one or more wavelengths selected may be emitted using the adjusted values of power level and/or length of time (i.e., those which reduce the difference between the determined parameter and a stored value of the parameter to within a predetermined tolerance) when measuring the one or more physiological signs.

The method may comprise the optical sensor recording an initial optical signature of the person of a given skin type/profile without any calibration, i.e., without any adjustments.

The one or more wavelengths selected may be the optimum wavelength(s) for measuring the one or more physiological signs of the person, i.e., those expected to give the most accurate and/or reliable readings for the one or more physiological signs being monitored. The one or more wavelengths may be selected based on historical data from measuring the physiological signs of people of the assigned skin profile category. For instance, it may be found that for skin profile A, a combination of green and infrared light is the optimum combination of wavelengths based on the data stored within the library.

The step of selecting one or more wavelengths of the plurality of wavelengths based on the optical signature or assigned skin profile category of the person to be used when measuring the one or more physiological signs, may comprise looking up one or more wavelengths to use for that optical signature or assigned skin profile category from a look up table. Additionally, or alternatively, the one or more wavelengths may be selected using a model that uses machine learning algorithms, based on light transport simulations or using any other known method.

The library of optical signatures may be organized into a plurality of categories. For example, the library of optical signatures may comprise 2-8 categories, wherein each category may comprise 2-6 optical profiles. Each category of skin profiles may have an assigned combination of one or more wavelengths which may form the basis for the selection in the method. This assigned combination of one or more wavelengths may be that which is regarded as optimum or sufficient for that skin profile category.

The method may allow suitable wavelengths for a given skin profile category to be used when measuring the physiological signs. The historical database may comprise information on the optimum wavelengths for each optical signature or group of skin profiles.

The method of selecting wavelengths to use in the physiological sign measurements based on the optical signature and/or skin profile category, in combination with the step of adjusting the power and/or time of the light pulses of each wavelength to reduce the difference between the determined parameter and the stored value of the parameter may improve the accuracy and reliability of the measurements of the one or more physiological signs.

The number of wavelengths used in the measuring of the one or more physiological signs may depend on the physiological sign being monitored. It may not be necessary for every wavelength that the optical sensor can emit to be used when measuring the one or more physiological signs, and so the above method may be beneficial in selecting suitable wavelengths for a given skin profile category of the person when measuring the one or more physiological signs.

In the case of the physiological sign being breathing rate or pulse rate, one wavelength may be sufficient to monitor the physiological sign. In this case, there may be a particular wavelength for a given optical signature or skin type that gives the most accurate and/or reliable reading. For example, for a person with a light skin tone selecting a shorter wavelength may give a more accurate result and for a person with a darker skin stone selecting a longer wavelength may give a more accurate result. The calibration method may give an assessment or indication of skin type (e.g., from the optical signature) that allows a selection of one or more wavelength to use to be made. It may also be the case, that even if it is possible to monitor a physiological sign using a single wavelength, signals from two or more different wavelengths may provide a more accurate and/or reliable reading. In the case of the physiological sign being blood oxygen saturation, two or more different wavelengths may be required. Similarly, there may be a particular combination of wavelengths for a given skin type that gives the most accurate and/or reliable reading. The calibration method may give an assessment or indication of skin type (e.g., from the optical signature) that allows a selection of a combination of wavelengths to use to be made.

Once the calibration method has been performed (i.e., the power levels and/or emission length of time of one or more wavelengths has been adjusted and/or the one or more wavelengths to use has been selected), one or more physiological signs may be measured using the optical sensor. Once the calibration method has been completed the sensor may indicate (e.g., visually and/or audibly) that the sensor is ready to measure one or more physiological signs of the person.

This calibration method may be performed before the optical sensor is used to monitor one or more physiological signs of the person. Additionally, or alternatively, the calibration method may be performed during the measuring of one or more physiological signs. For example, after using the optical sensor to monitor one or more physiological signs for a period of time, e.g., for 5 minutes, the calibration method may be performed. This may be a repeat of the calibration method that was performed before the one or more physiological signs were started to be monitored. This may ensure that the optical sensor is calibrated over the entire period of use of the sensor, e.g., to accommodate for adjustments or drift of any of the components of the sensor and/or change of condition of the person.

Although not essential, it is possible that the calibration method of the eighth aspect may comprise one or more or all of the steps of the calibration method of the sixth aspect. The above description in relation to the sixth aspect is thus applicable to this eighth aspect.

Thus the method may comprise determining the parameter (e.g., the signal-to-noise ratio) for each signal at each wavelength of light. This step of determining the parameter may be performed after the step of selecting one or more wavelengths of the plurality of wavelengths based on the optical signature and/or assigned skin profile category of the person to be used when measuring the one or more physiological signs. The method may thus comprise determining the parameter for each signal corresponding to the one or more wavelengths selected for use in measuring the one or more physiological signs only.

The method may comprise comparing the determined parameter to a stored value of the parameter for each wavelength of light. The method may comprise comparing the determined parameter to a stored value of the parameter for each of the one or more wavelengths selected for use in measuring the one or more physiological signs only.

The method may comprise determining a difference between the determined parameter to a stored value of the parameter for each wavelength of light. The method may comprise comparing the difference between a determined parameter to the stored value of the parameter for each wavelength of light to a predetermined tolerance.

The method may comprise adjusting the power and/or time of the one or more light pulses at each wavelength to reduce the difference between the determined parameter and the stored value of the parameter. The adjustment of the power and/or time of the light pulses at each wavelength may be to reduce the difference to be within the predetermined tolerance.

This is advantageous as it may ensure that the light pulses for each wavelength of light to be used in measuring one or more physiological signs are emitted using suitable properties such that the recorded signal comprises an acceptable parameter, such as the signal-to-noise ratio. This may improve the quality of the recorded signal for each wavelength so that a more accurate and/or reliable measurement of the one or more physiological signs may be recorded using the one or more selected wavelengths for the particular optical signature and/or skin profile category of the person.

The parameter may be any quantifiable parameter related to the recorded signal for each wavelength. Furthermore, the parameter may be easily measurable or easily derivable, quantifiable parameter. For example, the parameter may be one of irradiance, intensity or the square of intensity. The intensity and square of intensity may be a reflected intensity of the signal for each wavelength of light.

The parameter may be the signal to noise ratio for each signal at each wavelength of light. Each wavelength of light may therefore comprise a stored signal to noise ratio which may be used in the comparison step of the method.

The steps of determining the parameter for each signal at each wavelength of light, comprising comparing the determined parameter to a stored value of the parameter for each wavelength of light, and adjusting the power and/or time of the light pulses at each wavelength to reduce the difference between the determined parameter and the stored value of the parameter ratio may be carried out only for the one or more wavelengths selected to be used when measuring the one or more physiological signs. Similarly, the steps of determining a difference between the determined parameter to a stored value of the parameter for each wavelength of light, and comparing the difference between a determined parameter to the stored value of the parameter for each wavelength of light to a predetermined tolerance may be carried out only for the one or more wavelengths selected to be used when measuring the one or more physiological signs.

This is beneficial as it may reduce the amount of adjustment required during the calibration method. Instead of adjusting the power and/or time of the light pulses for each wavelength, the process can be carried out more efficiently by first selecting the one or more wavelengths to be used for measuring the physiological signs, and then only adjusting the power and/or time for those wavelengths.

The predetermined tolerance may be up to ±20% of the stored signal-to-noise ratio, optionally up to +15%, optionally up to ±10%, optionally up to ±5%, optionally up to ±2% of the stored signal-to-noise ratio.

The known power level and/or known length of time for each light pulse may be a default power level and/or default length of time. The known/default power level and/or known/default length of time may be an initial power level and/or initial length of time. The default power level and/or default length of time may be average values. The average values may be determined by the manufacturer based on a database.

The known power level and/or known length of time for each light pulse may be a mid-power level and/or mid length of time. This may mean that the power level and/or length of time may be both increased and decreased from the known/default.

The known power level and known length of time may be average values across all skin profiles. The step of adjusting the power and/or time of the light pulses at each wavelength may comprise increase or decreasing one or more of the power and/or time. For example, the method may comprise increasing the power of the light pulse and reducing the time of the light pulse. As a further example, the method may comprise increasing the power of the light pulse and increasing the time of the light pulse, or decreasing the power of the light pulse and decreasing the time of the light pulse, or decreasing the power of the light pulse and increasing the time of the light pulse.

As will therefore be appreciated, the optical sensor may be arranged such that both the power of the light pulse and the time of the light pulse can be adjusted. However, even when the optical sensor is arranged such that both the power of the light pulse and the time of the light pulse can be adjusted, the method may comprise only adjusting one of power of the light pulse or the time of the light pulse, or both.

In other words, the optical sensor may be arranged such that the power of the light pulse and the time of the light pulse are separate tunable parameters for each of the one or more wavelengths. This may provide greater adjustability and precision when calibrating the optical sensor to reduce the difference between the determined parameter and the stored value of the parameter.

The step of adjusting the power and/or time of the light pulses at each wavelength may include choosing to adjust one or both of the power and time of the light pulses for each wavelength. This step of choosing to adjust one or both of the power and time of the light pulses for each wavelength may be based on one or more of the recorded signals for the one or more light pulses at each wavelength and the comparison between the determined parameter for each signal at each wavelength with a stored value of the parameter at each wavelength.

Accordingly, it will be appreciated that in some instances, it may only be necessary for the power of the light pulse to be adjusted, and in other instances it may only be necessary for the time of the light pulse to be adjusted, or it may be necessary for both the power of the light pulse and the time of the light pulse to be adjusted. It is therefore beneficial for the optical sensor to be configured such that it is possible to adjust both the power and time of the light pulse, so that the calibration method can then be decided accordingly. The method may comprise determining whether to adjust the power of the light pulse or the time of the light pulse, or both.

The adjustment of the power and/or length of time of each of the one or more light pulses may be used to adjust the light dose provided by each of the one or more light pulses.

The term light dose may be understood as the total energy of the light absorbed by the tissue for a given light pulse. In other words, the light dose may be the product of the power of the light pulse and the length of time the light pulse is absorbed for. The same light dose may therefore be achieved by increasing the power of the light source and decreasing the length of time that the light source is emitting for, or vice versa. For example, it may be possible to have the same light dose by increasing the power whilst keeping the length of time the light pulse is emitted for constant, or only increasing the length of time for which the light pulse is emitted, whilst keeping the power of the light pulse constant.

The method may comprise adjusting only one of the power and/or time of the light pulse. In particular, the method may comprise increasing or decreasing only one of the power and/or time of the light pulse for each wavelength.

The method may comprise adjusting the power and/or time of the light pulse of each wavelength in the same manner. For example, both the power and time of the light pulse of each wavelength may be increased for each wavelength. Alternatively, the method may comprise adjusting the power and/or time of the light of each wavelength in a different manner, i.e., independently. In particular, for some wavelengths the power and time of the light pulse may be increased, meanwhile for other wavelengths the power may be increased and the time may be decreased. This may depend on the difference between the determined parameter and the stored value of the parameter for each wavelength. For example, it may be that for certain longer wavelengths a higher power and longer time is required to reduce the difference, while for shorter wavelengths a lower power and shorter time is required to reduce the difference.

For lighter skin tones, it may be necessary to decrease the power level and/or length of time of the emitted signal compared to the known/initial power level and known/initial length of time. Conversely, for darker skin tones, it may be necessary to increase the power level and/or length of time compared to the known/initial power level and known/initial length of time.

Following the step of adjusting the power and/or time of the one or more light pulses at each wavelength, the method may comprise repeating one or more times the steps of emitting one or more light pulses at a one or more different wavelengths (e.g., in sequence) using the one or more light sources, recording the signal for the light pulses at each wavelength (e.g., in sequence) using the detector; determining a parameter for each signal at each wavelength of light; and comparing the determined parameter to the stored value of the parameter for each wavelength. The repeated steps may comprise emitting the one or more light pulses at an adjusted power level for an adjusted length of time, i.e., the power level and length of time resulting from the last adjustment step of the last repeat of the method. The method may be repeated until the difference between the determined parameter and stored value of the parameter for each wavelength of light is within a predetermined tolerance. The method may be repeated up to a certain number of times, e.g., up to 100 times. If the difference between the determined parameter and stored value of the parameter for each wavelength of light is not within a predetermined tolerance within a certain number of iterations, e.g., within 100 repeats, of the method, the optical sensor may be arranged to indicate, e.g., audibly and/or visually, that it is not suitable for use. This may prevent an optical sensor that would not give sufficiently accurate readings from being used.

In operation, the difference between the determined parameter and the stored value of the parameter for one or more of the plurality of wavelengths may be within a predetermined tolerance, while the difference between determined parameter and the stored value of the parameter for the remaining wavelengths of the plurality of wavelengths may be outside a predetermined tolerance.

For example, in the case of the plurality of different wavelengths comprising eight different wavelengths, the difference between the determined parameter and the stored value of the parameter for five of the different wavelengths may be within the predetermined tolerance, and for the other three different wavelengths the difference between the determined parameter and the stored value of the parameter may be outside the predetermined tolerance. In this case, the method may comprise adjusting the power and/or time of the light pulse only for the wavelengths where the difference between the determined parameter and the stored value of the parameter for one or more of the plurality of wavelengths is outside a predetermined tolerance. Alternatively, in this instance the method may still comprise adjusting the power and/or time adjusting the power and/or time of the light pulse for each of the plurality of wavelengths in order to further reduce the difference between the determined parameter and the stored value of the parameter.

In the case that the difference between the determined parameter and the stored value of the parameter for one or more of the plurality of wavelengths is within a predetermined tolerance, while the difference between determined parameter and the stored value of the parameter for the remaining wavelengths of the plurality of wavelengths is outside a predetermined tolerance, the method may comprise measuring the physiological signs of the person only using one or more of the wavelengths of light for which the difference between the determined parameter and the stored value of the parameter for one or more of the plurality of wavelengths is within a predetermined tolerance.

The method may comprise indicating that the optical sensor is calibrated and/or ready for use once the difference between the determined parameter and the stored value of the parameter for each wavelength is within a predetermined tolerance. The method may comprise indicating that the optical sensor is calibrated and/or ready for use once the difference between the determined parameter and the stored value of the parameter for sufficient wavelengths to be able to monitor one or more physiological signs is within a predetermined tolerance. The indication may comprise an audible and/or visual alert.

The term “in sequence” should be interpreted such that the one or more light pulses of each wavelength are emitted at a different time, e.g., one after the other and/or recording a signal for each wavelength occurs at different times. In the case where multiple light sources are configured to emit light pulses of the same wavelength the method may comprise emitting each of the light pulses of the same wavelength simultaneously. For example, in the case of the one or more light sources comprises two light sources both configured to emit infrared light, the method may comprise both infrared light sources emitting their respective light pulses at the same time.

Alternatively, in the case where multiple light sources are configured to emit light pulses of the same wavelength the method may comprise emitting each of the light pulses of the same wavelength sequentially. For example, in the case of the one or more light sources comprises two light sources both configured to emit infrared light, the method may comprise both infrared light sources emitting their respective light pulses one after the other.

As with preceding aspects, the present invention also extends to an optical sensor which is configured to operate in accordance with the method described in the eighth aspect above. Thus the present invention may provide an optical sensor that is configured to perform the calibration method, including one or more or all of the optional features. This may be the optical sensor of the first aspect.

The optical sensor may comprise one or more broadband light sources. The optical sensor may comprise one or more wavelength sensitive detectors, and/or one or more detectors provided with optical filters.

Viewed from an ninth aspect, there is provided an optical sensor for measuring one or more physiological signs, the sensor comprising one or more detectors, and one or more light sources, wherein once the device is attached to a person, the optical sensor is for emitting one or more light pulses at a plurality of different wavelengths (e.g., in sequence) using one or more light sources, wherein each light pulse at each wavelength is emitted at a known power level and for a known length time; record a signal for the light pluses at each wavelength (e.g., in sequence) using one or more detectors to create an optical signature of the person; and select one or more wavelengths of the plurality of wavelengths based on the optical signature of the person to be used when measuring the one or more physiological signs.

The optical sensor may be configured to compare the optical signature of the person to a library of stored optical signatures in order to select the one or more wavelengths to be used when measuring the one or more physiological signs.

The library of optical signatures may be organized into a plurality of skin profile categories. Each skin profile category may comprise a predetermined one or more wavelengths to be used when measuring the one or more physiological signs. The step of comparing the optical signature of the person to the library may include assigning a skin profile category to the person and selecting the one or more wavelengths to be used when measuring the one or more physiological signs based on the assigned skin profile category.

The optical sensor may comprise a processor. The optical sensor and/or processor may be configured to carry out (or cause the execution of) any of the steps of the invention of the eighth aspect above, including one or more or all of the optional features.

Moreover, the optical sensor may be the optical sensor of the first aspect, including one or more or all of the optional features.

The present invention may provide an optical sensor according to the first aspect that is configured to perform the methods of the fourth, sixth and eighth aspects of the invention.

As will be appreciated by the various optional features discussed therein, the steps of each calibration method may be combined to provide increased accuracy and/or reliability for the physiological signs measuring.

Accordingly, viewed from a tenth aspect, there is provided a method of calibrating an optical sensor for measuring one or more physiological signs of a person after the device is attached to the person, the sensor comprising one or more detectors and one more light sources, the method comprising the following steps after the device is attached to the person: emitting one or more light pulses at one or more different wavelengths using one or more light sources, wherein each light pulse at each wavelength is emitted at a known power level and for a known length time; recording a signal for the light pulses at each wavelength using one or more detectors to create an optical signature of the person; determining a parameter for each signal at each wavelength of light; comparing the determined parameter to a stored value of the parameter for each wavelength of light; adjusting the power and/or time of the light pulses at each wavelength to reduce the difference between the determined parameter and the stored value of the parameter; and selecting one or more wavelengths of the plurality of wavelengths based on the optical signature of the person to be used when measuring the one or more physiological signs.

The method according to the tenth aspect may include any of the features discussed in the sixth and eighth aspects above. Furthermore, the optical sensor used in the tenth aspect may be as described in the first aspect above.

The present invention also extends to the optical sensor specifically being configured to carry out the steps of the method according to the tenth aspect.

Accordingly, viewed from an eleventh aspect, there is provided an optical sensor for measuring one or more physiological signs, the sensor comprising one or more detectors, and one or more light sources, wherein once the device is attached to a person, the optical sensor is configured to emit one or more light pulses at a plurality of different wavelengths (e.g., in sequence) using one or more light sources, wherein each light pulse at each wavelength is emitted at a known power level and for a known length time; record a signal for the light pluses at each wavelength using one or more detectors to create an optical signature of the person; determine a parameter for each signal at each wavelength of light; compare the determined parameter to a stored value of the parameter for each wavelength of light; adjust the power and/or time of the light pulses at each wavelength to reduce the difference between the determined parameter and the stored value of the parameter; and select one or more wavelengths of the plurality of wavelengths based on the optical signature of the person to be used when measuring the one or more physiological signs.

The optical sensor may comprise a processor. The optical sensor and/or processor may be configured to carry out (or cause the execution of) any of the steps of the invention of the tenth aspect above, including one or more or all of the optional features.

According to a further, twelfth, aspect, there is provided a method of calibrating an optical sensor for measuring one or more physiological signs of a person, the sensor comprising one or more detectors and one more light sources, the method comprising the following steps after the device is attached to the person: emitting one or more light pulses at a plurality of different wavelengths (e.g., in sequence) using one or more light sources, wherein each light pulse at each wavelength is emitted at a known power level and for a known length time; recording a signal for the light pluses at each wavelength using one or more detectors to create an optical signature of the person; selecting one or more wavelengths of the plurality of wavelengths based on the optical signature of the person to be used when measuring the one or more physiological signs; determining a parameter for each signal of the one or more wavelength of light selected to be used when measuring the one or more physiological signs; comparing the determined parameter to a stored value of the parameter for each one or more selected wavelengths of light; and adjusting the power and/or time of the light pulses for each of the one or more selected wavelengths to reduce the difference between the determined parameter and the stored value of the parameter.

The method may be beneficial as the computational steps of determining the parameter (e.g., signal-to-noise ratio) for each wavelength may only be carried out for the wavelengths selected for use according to the optical signature of the person.

The method according to the twelfth aspect may include any of the features discussed in the sixth and eighth aspects above. Furthermore, the optical sensor used in the twelfth aspect may be as described in the first aspect above.

Viewed from a thirteenth aspect, there is provided an optical sensor for measuring one or more physiological signs, the sensor comprising one or more detectors, and one or more light sources, wherein once the device is attached to a person, the optical sensor is configured to emit one or more light pulses at one or more different wavelengths (e.g., in sequence) using one or more light sources, wherein each light pulse at each wavelength is emitted at a known power level and for a known length time; record a signal for the light pluses at each wavelength using one or more detectors to create an optical signature of the person; select one or more wavelengths of the plurality of wavelengths based on optical signature of the person to be used when measuring the one or more physiological signs; determine a parameter for each signal of the one or more wavelength of light selected to be used when measuring the one or more physiological signs; compare the determined parameter to a stored value of the parameter for each one or more selected wavelengths of light; and adjust the power and/or time of the light pulses for each of the one or more selected wavelengths to reduce the difference between the determined parameter and the stored value of the parameter.

It should be noted that although thirteen independently claimable aspects of the invention are recited above, these are all sensors and methods that may be used together. For example, the particular optical sensor of the first aspect may be used to perform one or more or all of the disclosed methods and any of the disclosed methods may be performed by any of the disclosed sensors. As a result, any of the features of one aspect recited herein, including the optional features of that aspect may be applicable to any other aspect. Accordingly, even if there are any features that are disclosed only in relation to one or some of the aspects, such a feature can be equally applied to any of the other aspects. Accordingly, any disclosure herein should not be read as only disclosed in combination with the aspect it follows but rather should be understood to relate to (and hence be disclosed in combination with) any of the recited aspects of the invention.

### BRIEF DESCRIPTION OF THE DRAWINGS

Certain preferred embodiments of the present invention will now be described, by way of example only, with reference to the following drawings, in which:

FIG. 1 shows an optical sensor;

FIG. 2a shows an optical sensor unit mounted to an adhesive patch;

FIG. 2b shows the optical sensor unit disconnected from the adhesive patch;

FIGS. 3a and 3b show an underside of the optical sensor unit;

FIGS. 4a and 4b shows the optical sensor as part of a smart watch

FIG. 5 illustrates a method of initialising the optical sensor;

FIG. 6 illustrates a first method of calibrating the optical sensor;

FIG. 7 illustrates a second method of calibrating the optical sensor;

FIG. 8 illustrates a third method of calibrating the optical sensor; and

FIG. 9 illustrates a fourth method of calibrating the optical sensor.

### DETAILED DESCRIPTION

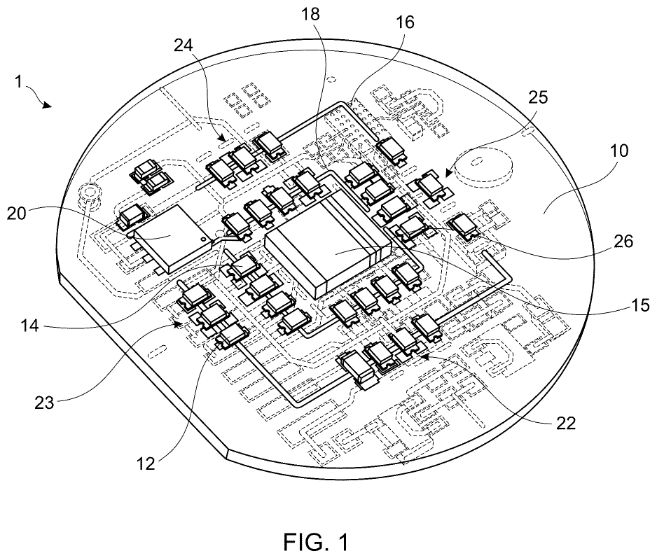

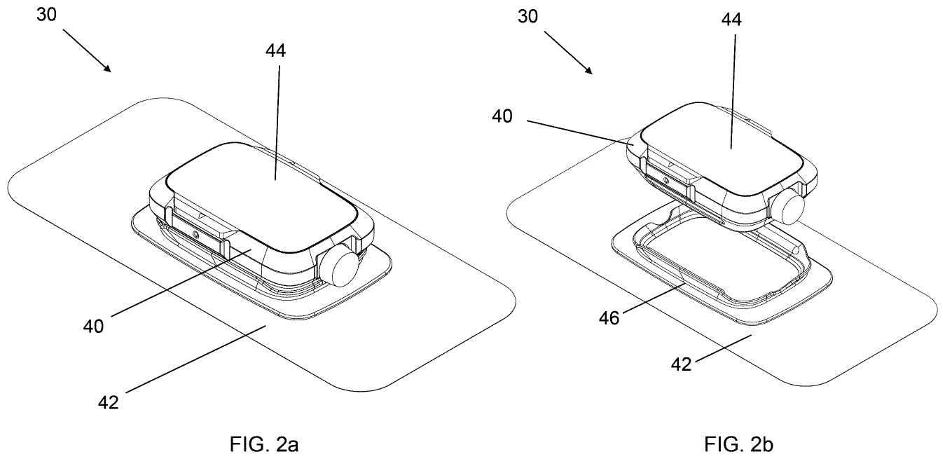

FIG. 1 depicts a printed circuit board (PCB) 10 for an optical sensor 1 for measuring one or more physiological signs of a person (such as an optical sensor shown in FIGS. 2a, 2b, 3a, 3b, 4a, or 4b). The physiological signs may include a person's vital signs such as pulse rate, breathing rate and blood oxygenation level. In use when the optical sensor 1 is attached to a person, this PCB 10 will face towards the skin of a person. The PCB 10 comprises a plurality of light sources 12, 14 surrounding a detector 15. The optical sensor 1 comprising the PCB 10 may be a PPG sensor, or any other known optical sensors for measuring one or more physiological signs of a person. The optical sensor is a reflectance type device in which the detector 15 is arranged to detect reflected light from the light sources 12,14. Hence the detector 15 is on the same surface as the light sources 12, 14.

The plurality of light sources 12, 14 are LEDs and are each for emitting light at a plurality of different wavelengths. The optical sensor 1 in FIG. 1 includes 28 light sources 12 and 14. Each light source 12, 14 is configured to emit light of a particular wavelength (i.e., a narrow band of wavelengths). In this specific example the light sources are configured to emit light pulses at seven different wavelengths, wherein each of the seven different wavelengths is emitted by four light sources 12, 14. In other words there are four light sources 12,14 that emit each wavelength.

The detector 15 shown is a photo detector but could be another type of detector such as a camera.

As shown in FIG. 1, the plurality of light sources 12, 14 are arranged in two concentric loops 16, 18. The outer loop 16 comprises light sources 12 which are configured to emit light pulses with a longer wavelength compared to those in the inner loop. The inner loop 18 comprises light sources 14 which are configured to emit light pulses with a shorter wavelength compared to those in the outer loop. In other words the longest wavelength of light emitted by an LED 14 in the inner loop 18 may be shorter than the shortest wavelength of light emitted by an LED 12 in the outer loop 16.

The seven different wavelengths in this example, in order of ascending wavelength, may be blue, dark green, light green, yellow, red, dark red, and infrared. The wavelengths emitted by the light sources may be within the range from 400 nm to 1300 nm, such as within a range of 460 nm to 940 nm. The light sources 12 for emitting red, dark red and infrared light are therefore positioned on the outer loop 16, while the light sources 14 for emitting blue, dark green light green and yellow light are positioned on the inner loop 18.

In addition to the inner loop 18 and outer loop 16, the plurality of light sources are arranged into four groups 22, 23, 24, 25 surrounding the detector 15. Each group 22, 23, 24, 25 is located at a different edge of the detector 15 and each group includes seven light sources. In each group 22, 23, 24, 25, the respective light sources are configured to emit light pulses of all seven different wavelengths. The light sources in each group 22, 23, 24, 25 may each be located the same distance from the center of the detector as the equivalent light source in another group. In other words, the blue light source of each group 22, 23, 24, 25 may be the same distance from the center of the detector as the blue light source of each other group. The plurality of light sources 12, 14 on each side of the detector 15 are positioned symmetrically about the detector. For example, in each group 22, 23, 24, 25 of light sources, the light sources 12 on the outer loop 16 are configured to emit red, dark red and infrared light. Similarly, the light sources on the inner loop 18 in each group 22, 23, 24, 25 are configured to emit blue, dark green and light green light. The light sources in one group may mirror those on the opposite side of the detector both in emittable wavelengths and position relative to the photo detector. The arrangement shown may ensure that the light field emitted about the detector 15 is uniform. This may help improve the accuracy and strength of the signal detected by the detector 15.

The optical sensor 1 is configured to attach to a person's skin, such as on their neck or wrist, using an attachment means such as an adhesive patch and/or strap in order to monitor one or more physiological signs. The specific physiological signs typically measured using the optical sensor 1 include pulse rate, breathing rate and blood oxygen saturation. In order to monitor blood oxygen saturation at least two different wavelengths are required. However, one wavelength is sufficient in order to monitor breathing rate and pulse rate, but the use of multiple wavelengths in combination can improve the accuracy of pulse rate and breathing rate measurements.

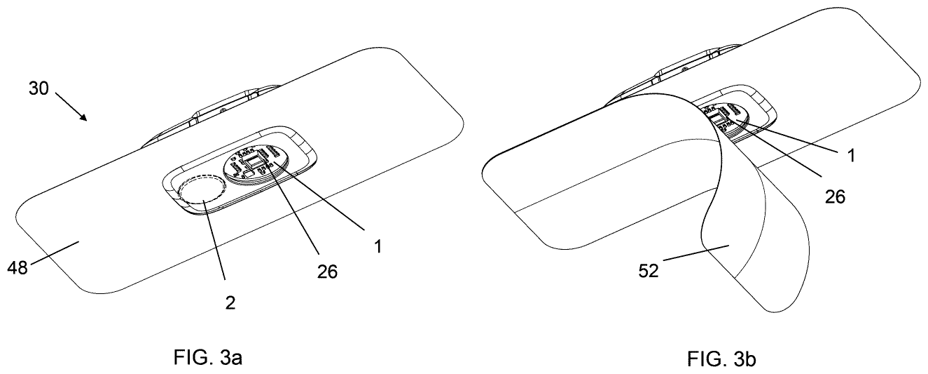

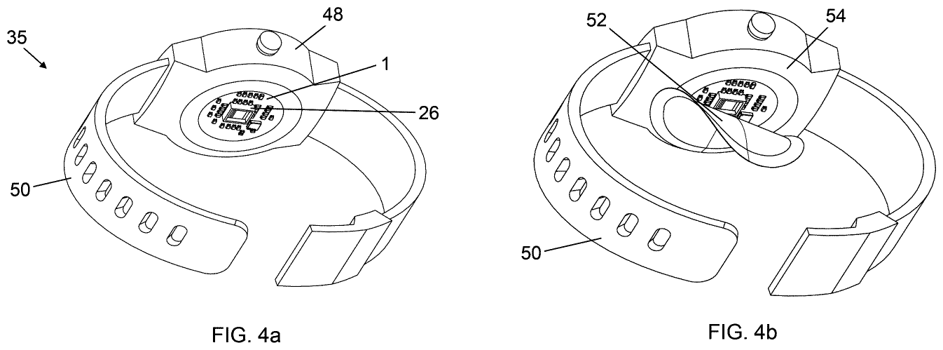

The optical sensor may comprise a screen 26 (see FIGS. 3a and 4a) which optically separates the plurality of light pulses 12, 14 from the detector 15. The screen 26 is present to prevent light pulses from the light sources 12, 14 from being detected directly by the detector 15, before being reflected from the tissue of the person. The screen 26 forms a loop around the detector 15 between the light sources 12, 14 and the detector 15. The screen 26 is formed of an opaque material that is opaque to all of the wavelengths of light emitted by the light sources 12, 14. The screen 26 may for example, be plastic. In addition, the detector 15 may be located within a recess within the first surface of the optical sensor 1. This may also be for the purpose of preventing light pulses from the light sources being detected directly by the detector 15, before being reflected from the tissue of the person.

The optical sensor 1 further comprises a temperature sensor 20 located on the PCB 10. The temperature sensor 20 is configured to monitor the temperature of the environment close to the first surface of the optical sensor. When the optical sensor is attached to a person, this may be the temperature of the person's skin. The temperature may be monitored in order to detect overheating of the person's skin due to the emission of light pulses into the skin. During use of the optical sensor on a person, if the temperature increases by more than a predetermined amount, an alert can be issued and the optical sensor 1 will stop emitting light pulses from the plurality of light sources 12, 14. Additionally, the temperature sensor 20 is used to determine whether the person's tissue is at a suitable temperature for accurate physiological signs readings to be obtained using the optical sensor and/or as a check that the optical sensor is in close enough proximity to a person's skin for accurate readings to be made. For example, if the detected temperature is not within a certain temperature range an alert can be issued and/or the optical sensor 1 may not output any physiological signs readings. This is because it may indicate that the person is not in an appropriate state for accurate readings to be made and/or that the sensor 1 is not attached properly to the person.

The optical sensor 1 further comprises a processor which is not present on the first surface of the optical sensor and is therefore not depicted in FIG. 1. The processor may for example, be housed on the second surface on the opposite side to the first surface. The processor may be used to control the operation of the optical sensor.

FIGS. 2a and 2b depict a perspective view of a monitoring device 30 for monitoring physiological signs in a patient. The monitoring device 30 comprises a sensor unit 40 which includes a display 44 and the optical sensor as depicted in FIG. 1 (see FIGS. 3a and 3b). The display 44 is used to display values and/or indications for the measured physiological signs.

The sensor unit 40 can be connected to a frame 46 which is attached to an adhesive patch 42. The underside of the adhesive patch 42 (see FIG. 3a) can be stuck to the skin of a person. For example, the adhesive patch may be attached to the skin of a person to monitor the one or more physiological signs.

The adhesive patch 42 and frame 46 may remain attached the skin of a patient while they are in hospital. The sensor unit 40 can then be removed or attached as required as shown in FIG. 2b. The sensor unit 40 may be attached to the frame by exerting sufficient force on the sensor unit in the direction towards the frame 46 such that the flange of the frame 46 clips on to the outer edge of the sensor unit 40.

FIGS. 3a and 3b show the underside of the monitoring device 30 from FIG. 2a. In particular, FIG. 3a shows the underside surface 48 of the adhesive patch 42 which can be used to attach the monitoring device 35 to the skin of the person. The sensor unit 40 comprises the optical sensor 1 as depicted in FIG. 1, including the screen 26 which shields the detector 15 from receiving direct light from the plurality of light sources 12. The sensor unit 40 further comprises a separate acoustic sensor 2.

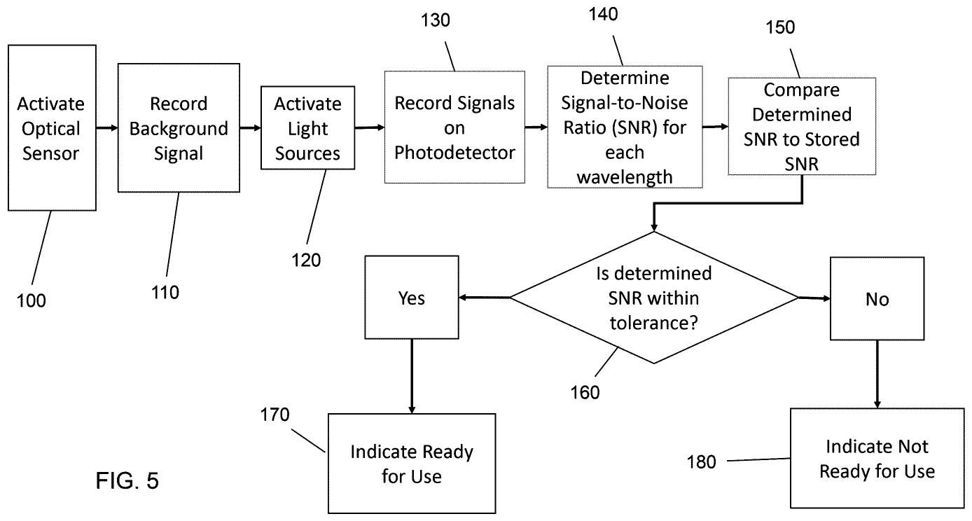

As shown in FIG. 3b, the monitoring device 35 comprises a reflective cover 52 which may be positioned over the underside surface 48 of the adhesive patch 42. The reflective cover 52 may cover the optical sensor 1 for use as part of the initialisation method described in FIG. 5 below. In addition, the reflective cover 52 may be used to protect the adhesive nature of the underside surface 48 of the adhesive patch 42.

FIGS. 4a and 4b depict a smart watch 35 which comprises a watch portion 48 and a strap portion 50 for attaching the smart watch 35 to the wrist of a person. The smart watch 35 comprises the optical sensor 1 as depicted in FIG. 1 and including all of the features described in relation to said Figure. The optical sensor 1 is configured to measure the one or more physiological signs of a person wearing the smart watch 35.

As with the monitoring device 35, the underside surface 54 of the watch portion 48 comprises a reflective cover 52. The reflective cover 52 is arranged to cover the optical sensor 1 during the initialisation method discussed in more detail below in relation to FIG. 5.

FIG. 5 depicts a method of initialising the optical sensor before use on a person. The initialisation takes place before the optical sensor 1 is used and may take place within a set known environment such an in the manufacturer's packaging and/or with the reflective cover 52 mounted over the light sources 12, 14 and detector 15. In any event, it should take place prior to the optical sensor 1 being fixed to the person, and it would typically include the first surface 10 being covered by the reflective cover 52 with known properties to ensure maximum good reflectance of the light pulses and under controlled conditions. This has the additional benefit of preventing any other signals being detected by the detector 15 and affecting the readings of the detector 15.

The method comprises activating 100 (i.e., turning on) the optical sensor and recording 110 a background signal. The background signal is recorded 110 prior to the plurality of light sources 120 being activated and hence the optical sensor 1 is configured to record a signal at the detector 15 in absence of any light pulses. This step 110 may be used to check that the detector is working as expected and to give a reading for the background light detected. Once the background signal has been recorded 110, the method comprises activating 120 (i.e., turning on) the plurality of light sources 12, 14 and emitting one or more light pulses for each different wavelength in sequence. Typically, light pulses of the same wavelength but from different light sources are emitted simultaneously, but the light pulses of each different wavelength are emitted sequentially, i.e., at different times. For example, the four light sources 14 configured to emit light pulses of blue light emit said light pulses at the same time. Once this has been done for a certain length of time, the four light sources 14 configured to emit dark green light emit said pulses at the same time, after the blue light has been emitted by the respective light sources 14.

The method comprises recording 130 signals corresponding to the light pulses from each wavelength at the detector 15. This is achieved by time-multiplexing the detected signals at the detector 15 in correspondence with the emission of light of each wavelength so as to get a reading for each wavelength. Additionally or alternatively, the signals for each different wavelength may be detected sequentially, e.g., using a wavelength sensitive detectors, and/or one or more detectors provided with optical filters.

The processor then determines 140 a parameter for the recorded signals at each wavelength. In this example, the parameter is the signal-to-noise ratio (SNR) of the signal but it could also be, or include, other measurable and determinable quantities such as irradiance, intensity or square of intensity of the detected signal.

The signal to noise ratio may be the ratio of the signal power (i.e., power of the emitted light pulses) to the noise power (i.e., power of detected signal).

The SNR for each wavelength can be determined using any well-known technique. However, in the present case the SNR is determined by comparing the intensity and/or variation in amplitude of the light pulse emitted from the light source to the intensity and/or variation in amplitude of the light pulse recorded by the detector 15. One alternative would be to compare the amplitude of the pulsating signal recorded for each wavelength to the noise floor of the device. The noise floor in this instance is the background signal recorded by the detector prior to the light pulses being activated. The noise floor in this instance would effectively be the total signal recorded by the detector 15 when detecting the emitted signals.

The determined SNR for each wavelength is then compared 150 to a stored SNR (or other parameter if a parameter other than SNR is being used) for each wavelength. The stored SNR depends on the properties of the optical sensor, e.g., each light source 12, 14, and the detector 15 and their precise arrangement on the optical sensor 1. The stored SNR for a particular optical sensor 1 may been determined under controlled conditions during manufacture when the sensor 1 is known to be working optimally. Thus the SNR may be determined and set by the manufacturer of the sensor 1. The stored SNR is stored within a look-up table which is stored for access by the processor of the optical sensor 1. Each optical sensor 1 will have a bespoke look-up table of stored SNR values due to the different properties and working parameters of the optical sensor 1 and components thereof. The stored SNR is determined during performance testing before the optical sensor 1 is supplied to the consumer. In order to allow for a like-for-like comparison between the determined SNR and the stored SNR (or other parameter, if used), the light pulses are emitted with the same parameters as those used in determining the stored SNR (or other parameter) values and ideally under the same conditions (hence why the initialisation is performed in a box or with a cap over the sensor).

The method then comprises determining 160 whether the determined SNR is within a predetermined tolerance of the stored SNR, e.g., within +−2% of the stored SNR for each wavelength. If it is, then it suggests the light sources are working properly. In this case the method comprises indicating 170 that the optical sensor is ready for use. If the determined SNR for one or more wavelengths is outside a predetermined tolerance of the stored SNR e.g., outside +−2% of the stored SNR for each wavelength, then the method comprises indicating 180 that the optical sensor 1 is not ready for use. The indication in each case may be a visual or audible alert such as text stating that the optical sensor 1 is ready for use.

Although not shown, if it is determined that the SNR for one or more wavelengths is outside a predetermined tolerance of the stored SNR, steps 120, 130, 140, 150 and 160 of the method can be repeated. These steps may be repeated a given number of time, say 5, and if still one or more of the determined SNR for a wavelength is outside a tolerance of the stored SNR for that wavelength the method comprises indicating 180 that the optical sensor 1 is not ready for use. This may suggest that one or more of the light sources 12, 14 and/or detector is not working properly. The user may check the environment of the optical sensor, e.g., check it is correctly in the box or covered by the cover and repeat the initialisation method. However, it may be that the optical sensor 1 is faulty or malfunctioning and may need to be returned to the manufacturer for a service.

The initialisation method may be performed, i.e., repeated, before each use of the optical sensor.

Once the optical sensor has been initialised according to the method depicted in FIG. 5 and it has been indicated that the sensor is ready for use, the optical sensor may then be attached to the person in order to monitor the one or more physiological signs. Optical sensors 1 for measuring one or more physiological signs may have been designed to work with a particular skin type and thus may have reduced accuracy when measuring people of skin types that differ from this particular skin type. For example, darker skin tones may filter out more light of certain wavelength, and skin profiles of elderly people may result in altered scattering of light, both of which may reduce the accuracy and reliability of the readings, unless accounted for. It is therefore desirable to calibrate the optical sensor 1 to the skin of the particular person in order to improve the accuracy of the physiological sign measurements.

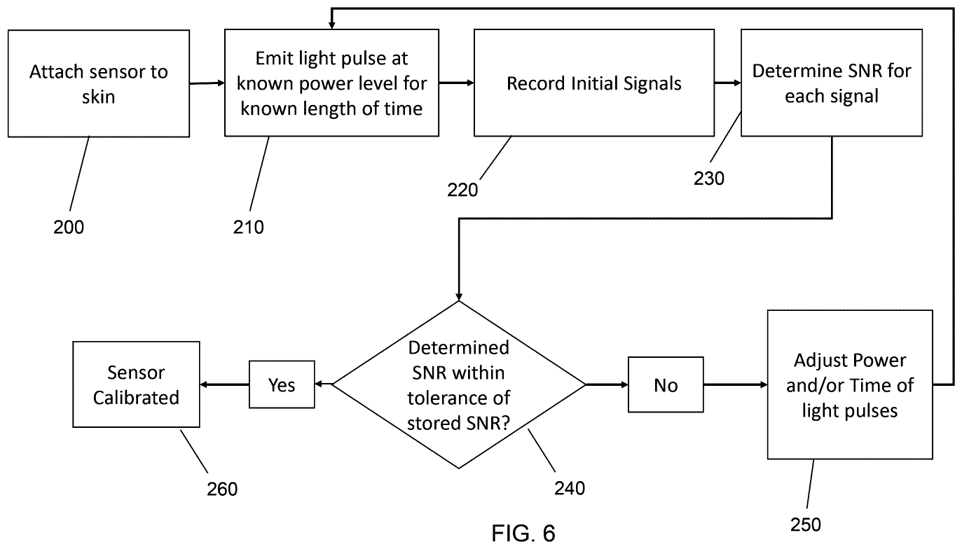

FIG. 6 depicts a first calibration method used by the optical sensor 1. As a first step, the method comprises attaching 200 the sensor to the skin of the person. In this step, the optical sensor 1 is attached to a part of the person, such as the neck or wrist of the person, using a known attachment means such as an adhesive patch. In addition, or as an alternative, the optical sensor 1 may be provided with a band or strap which wraps around part of the person. In either case, the optical sensor 1 is attached to the person such that the first surface of the sensor, comprising the plurality of light sources 12, 14, and the detector 15, is facing the skin of the person and in close proximity thereto, e.g., within 5 mm of the skin of the person. If the sensor had been in a box or covered with a cap/cover for the initialisation method, the sensor is removed from the box and/or the cap/cover is removed.

The optical sensor 1 may then be turned on, e.g., by pressing a button on the device. At this stage the optical sensor may then indicate it is on and that it is calibrating.

This first calibration method shown in FIG. 6 comprises emitting 210 one or more light pulses at each different wavelength in sequence using the plurality of light sources 12, 14. Each light pulse is emitted at a known (initial) power level and for a known (initial) length of time.

The method then comprises recording 220 a signal for the light pulses at each wavelength using the detector 15. The recorded signal is from light pulses reflected from the tissue, including the skin, of the person. The method then comprises determining 230 a parameter for each wavelength of light and comparing 240 the determined parameter to a stored value of the parameter for each wavelength of light. As with the initialisation method, in this example of the first calibration method, the parameter used is the signal-to-noise ratio (SNR) of the signal.

If the initialisation method of FIG. 5 has been performed, the stored SNR may be the SNR determined 140 during the initialisation process depicted in FIG. 5, i.e., the stored SNR may be the SNR of the signals for each wavelength under certain controlled conditions prior to the optical sensor 1 being attached 200 to the person.

In comparing 240 the determined SNR to the stored SNR for each wavelength, a difference between the determined SNR and stored SNR for each wavelength is computed. If it determined that the difference between the determined and stored SNR is within a predetermined tolerance, then the sensor is regarded as calibrated 260. The optical sensor may indicate that this is the case.

If it is determined that the difference between the determined and stored SNR is outside a predetermined tolerance, then the method comprises adjusting 250 the power level and/or length of time of the light pulses being emitted to reduce the difference between the determined and stored SNR values for each wavelength. The steps 210, 220, 230 and 240 of the method are then repeated with the adjusted values for the power and/or time of each light pulse. The method can be repeated a number of times, e.g., for up to 100 times and/or continuously or a given length of time, say 1 minute, until the difference between the determined SNR and the stored SNR for each wavelength is within the predetermined tolerance.

The predetermined tolerance may be set at an appropriate level dependent on a known value that allows sufficiently accurate readings of the one or more physiological signs to be take. For example, the predetermined tolerance may be up to ±20% of the stored signal-to-noise ratio.

In certain instances, the difference between the determined SNR and the stored SNR for some of the plurality of different wavelengths may be within the predetermined tolerance, but the difference for the other wavelengths may be outside the predetermined tolerance. In this case, the method may comprise adjusting the power and/or time only for the light pulses configured to emit wavelengths where the difference is outside of the predetermined tolerance.

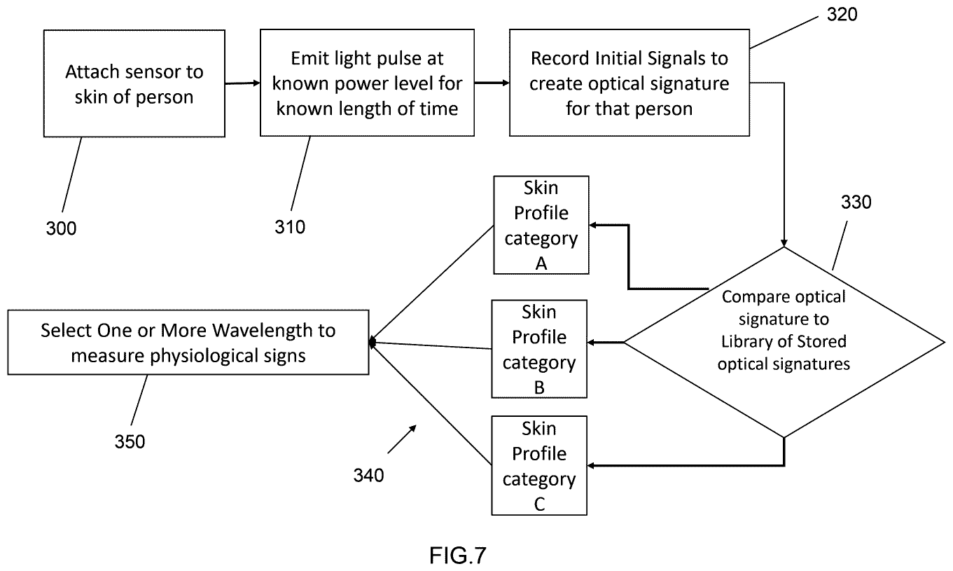

FIG. 7 depicts another method of calibrating the optical sensor 1. This may be additional or alternative to the calibration method shown in FIG. 6 (as illustrated in FIGS. 5 and 6 described below). This calibration method begins, the same as in FIG. 6, with attaching 300 the optical sensor 1 to the skin of the person. If the calibration method of FIG. 6 and FIG. 7 are performed in combination the step of attaching the sensor to the skin may be a single step performed once. In any event, the above description of the step 200 of attaching the sensor to the skin described above is equally applicable to this calibration method.

The calibration method of FIG. 7 then comprises emitting 310 the light pulses at each different wavelength in sequence using the plurality of light sources 12, 14. Each light pulse is emitted at a known power level and for a known length of time. This again is the same as in the method set out in FIG. 6.

The method comprises recording 320 a signal for the light pulses at each wavelength using the detector 15 to create an optical signature for the person. This optical signature is based on the recorded signals for the initial light pulses using the initial power level and length of time and provides an initial representation for how the skin and tissue of the person affects the reflectance of light at each wavelength.

The optical signature for the person is compared 330 to the library of stored optical signatures (this is based on historical data that has been collected and used to compile a database of how reflectance of each wavelength is affected by different skin profiles) in order to select 350 one or more wavelengths to be used when measuring the one or more physiological signs.

The library of optical signatures is organized 340 into a plurality of skin profile categories. Each skin profile category consists of a plurality of different optical signatures, which may each be similar in nature. Additionally, each of these skin profile categories has a predetermined set of one or more wavelengths to be used when measuring the physiological signs which provide the most accurate readings.

In the step of comparing 330 to the optical signature of the person to the library of optical signatures, a skin profile category is assigned to the person. The assigned skin profile category is based on the person's optical signature and would be the skin profile category which the person's optical signature most closely matches or falls within.

In the present case, the stored optical signatures are organized 340 into categories A, B and C. The method then comprises selecting 350 a combination of one or more wavelengths of the plurality of wavelengths based on the assigned skin profile category to be used when measuring the one or more physiological signs.

The library may also comprise the optimum wavelength, or combination of wavelengths to be used for the optical signatures within each skin profile category for measuring each particular physiological sign. For example, for optical signatures assigned to skin profile category A, a combination of dark green and dark red may be the optimum combination of wavelengths to be used when measuring the breathing rate of the person and hence the selected wavelength to measure breathing rate would be dark green and dark red wavelengths. Additionally, for the same optical signature falling within skin profile category A, the optimum combination of wavelength for measuring blood oxygen saturation may be red and infrared.

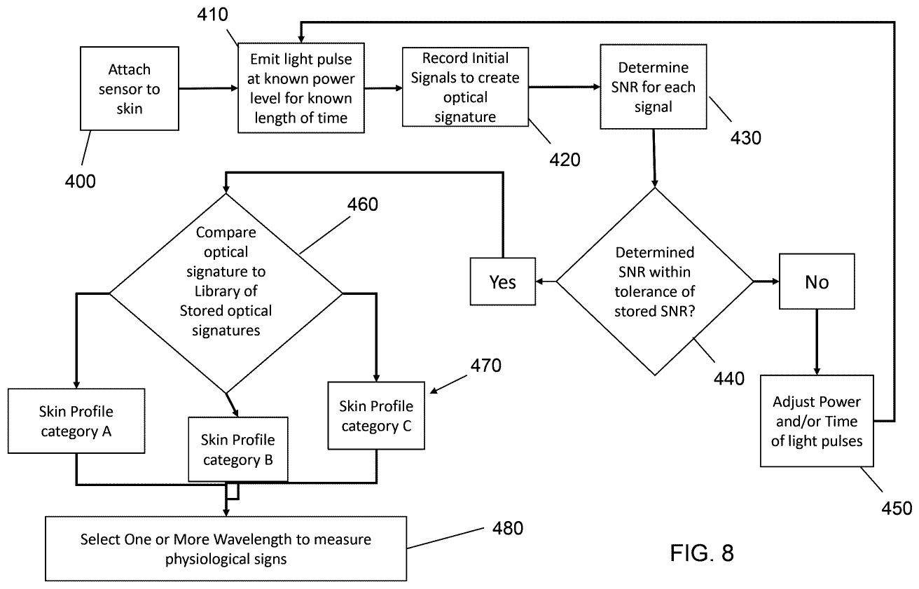

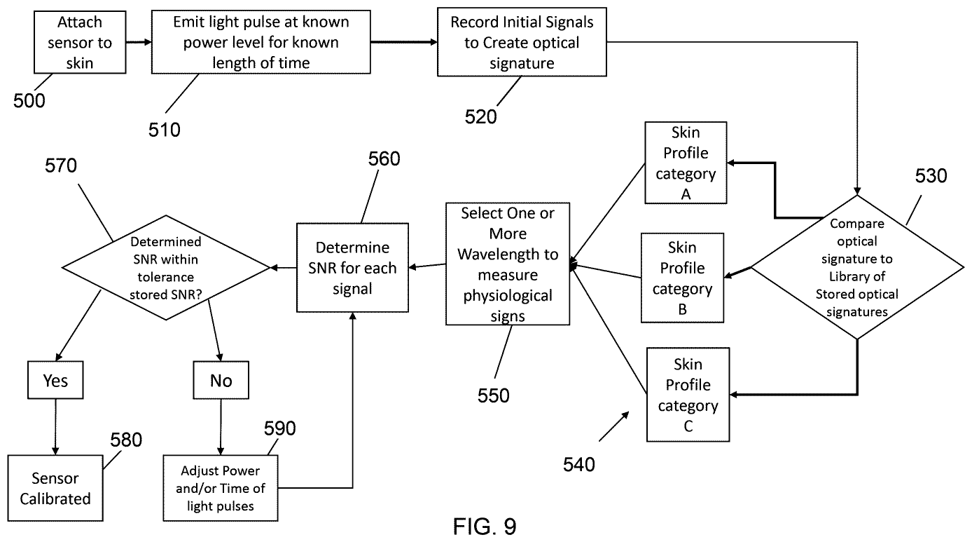

Although the method of calibrating the optical sensor depicted in FIGS. 6 and 7 can be performed independently and each provide benefits of improving the accuracy of the physiological signs measuring (even if the other calibration method is not performed), they could also be combined to form a further calibration method as depicted in FIG. 8 or 9.

The method according to FIG. 8 comprises attaching 400 the optical sensor 1 to the person. This may be as described above in relation to step 200 of FIG. 6. Light pulses at each different wavelength are then emitted 410 at an initial known power level for an initial known length of time. The method then comprises recording 420 the initial signals of each light pulses for each wavelength when emitted at the known initial power level and for the initial known length of time to create an optical signature for the particular person to which the optical sensor is attached.

The SNR (or other parameter) of the signal for each wavelength is then determined 430 and the determined SNR for each wavelength is compared 440 to a stored SNR (or other parameter) as in the calibration method depicted in FIG. 6. If the difference between the determined SNR and the stored SNR is greater than a predetermined tolerance, the method comprises adjusting 450 the power level and/or length of time of each light pulse to reduce the difference between the determined SNR and the stored SNR. The steps 410, 430 and 440 of the method are then repeated (for up to a given number of times such as 100 and/or for a given length of time, such as up to 1 minute) until the difference between the determined SNR and the stored SNR for each wavelength is within the predetermined tolerance. As discussed above in relation to FIG. 6, the stored SNR may be that determined during an initialisation method as shown in FIG. 5 or some other stored SNR, e.g., as set by the manufacturer. If after a given number of repetitions, such as 100, and/or after a given length of time, such as up to 1 minute, the determined SNR signal for each wavelength is not within the predetermined tolerance the optical sensor 1 may indicate that it is not possible to be used to record one or more physiological signs with that person.

If/once the difference between the determined SNR and the stored SNR is within a predetermined tolerance, it is determined that the signals are sufficient to get an accurate reading of one or more physiological signs and the method then compares 460 the optical signature of the person determined at 420 to a library of stored optical signatures as in the calibration method depicted in FIG. 7 described in more detail above.

Based on the comparison 460 of the optical signature of the person to the library of stored optical signatures, a skin profile category 470 is assigned to the person. The method then comprises selecting 480 a suitable combination of one or more wavelengths based on the assigned skin profile category to then be used for measuring the one or more physiological signs. Again this is described above in more detail in relation to FIG. 7.

The combination of both calibration methods from FIGS. 6 and 7 may be of particular benefit as it can achieve suitable parameters for the light pulses for each wavelength (FIG. 6) and then also select optimum suitable combination of wavelengths based on the assigned skin profile category (FIG. 7). This maximizes the chance that accurate and reliable readings of the one or more physiological signs can be achieved for the particular person to which the physiological signs measuring device is attached.

FIG. 9 depicts an alternative method of calibrating the optical sensor 1 comprising substantially the same steps as the method shown in FIG. 8. However, the order in which the steps of the method are performed differs.

As in the method of FIG. 5, the method of FIG. 9 comprises attaching 500 the sensor the skin of the person and emitting 510 a light pulse at each wavelength at an initial known power level for an initial known length of time. The signals are recorded 520 at the detector 15 for each wavelength to create an initial optical signature of the person. As in the method according to FIG. 7, the initial optical signature of the person is compared 530 to a library of stored optical signatures in order to assign 540 a skin profile category to the person.

Based on this comparison, the method then comprises selecting 550 a combination of one or more wavelengths of light to be used in measuring the one or more physiological signs.

The method then comprises determining 560 the SNR (or other parameter) only for each of the one or more wavelengths selected for use in measuring the one or more physiological signs. The determined SNR is then compared 570 to the stored SNR (or other parameter) for each of the one or more selected wavelengths. As explained above, the stored SNR may be that determined during the initialisation method depicted in FIG. 5 or may be some other stored SNR for that optical sensor. If the determined SNR is within a predefined tolerance, then it is determined 580 that the sensor is calibrated. If the determined SNR is outside of a predefined tolerance, then the power level and/or length of time of the light pulses for each of the one or more wavelengths selected for use in measuring the one or more physiological signs is adjusted 590 as in the method according to FIG. 6 and/or FIG. 5.

The steps of determining 560 the SNR for each wavelength and comparing 570 the determined SNR to the stored SNR are then repeated using the adjusted values for power level and length of time of each light pulse until the determined SNR for each wavelength is within a predefined tolerance of the stored SNR values.

The method according to FIG. 9 may have the added benefit of reducing the computational requirements and/or time of the calibration method as the steps of analyzing the signals and determining the SNR and then adjusting the power and/or time of the light pulses is only carried out for the one or more wavelengths selected for use, rather than for every possible wavelength that can be emitted by the optical sensor. This may therefore increase the speed and efficiency of the calibration process.

Whilst the methods of FIGS. 5 to 9 are described herein as being performed by the optical sensor 1, it should be appreciated that these methods are not limited to being performed by such a sensor and indeed may be performed using any optical sensor comprising one or more light sources and one or more detectors with the ability to emit and detect one or more wavelengths for measuring one or more physiological signs of a person.

The following clauses set out aspects of the present disclosure which may not be presently claimed but which may form basis for future amendments and/or a divisional application.
1. A method of initialising an optical sensor for measuring one or more physiological signs of a person, the sensor comprising one or more detectors and one more light sources, the method comprising the following steps before the device is attached to the person: emitting one or more light pulses at one or more different wavelengths using the one or more light sources, wherein each light pulse is emitted at a known power level for a known length of time; recording the signal for the one or more light pulses at each wavelength using the one or more detectors; determining a parameter for each signal at each wavelength of light; comparing the determined parameter to a stored value of the parameter for each wavelength; and determining that the optical sensor is ready for use if the determined parameter for each wavelength is within a set tolerance of the stored value of the parameter for each wavelength.
2. The method as described in clause 1, wherein the method further comprises recording a signal received using the one or more detectors when no light is being emitted by the one or more light sources.
3. The method as described in clause 1 or 2, wherein the stored value of the parameter is determined and stored before the optical sensor is supplied to a user.
4. The method as described in any of clauses 1, 2, or 3, wherein the determined parameter and the stored value of the parameter are ascertained under the same conditions.
5. The method as described in any preceding clause, wherein the method comprises indicating that the optical sensor is ready for use after it has been determined that the optical sensor is ready for use.
6. The method as described in any preceding clause, wherein the method further comprises determining that the optical sensor is not ready for use if the determined parameter for one or more of the wavelengths is outside a set tolerance of the stored value of the parameter for the respective wavelength.
7. The method as described in any preceding clause, wherein if it is determined that the parameter for one or more of the wavelengths is outside the set tolerance of the stored value of the parameter for the respective wavelengths, the method comprises repeating one or more times the steps of emitting one or more light pulses at a one or more different wavelengths using the one or more light sources, recording the signal for the one or more light pulses at each wavelength using the one or more detectors; determining a parameter for each signal at each wavelength of light; and comparing the determined parameter to a stored value of the parameter for each wavelength.
8. The method as described in clause 7, wherein if the parameter for at least one of the one or more wavelengths is outside of the set tolerance of the stored value of the parameter, the steps of emitting one or more light pulses at a one or more different wavelengths using the one or more light sources, recording the signal for the one or more light pulses at each wavelength using the one or more detectors; determining a parameter for each signal at each wavelength of light; and comparing the determined parameter to a stored value of the parameter for each wavelength are repeated a predetermined number of iterations, after which, if the parameter for at least one of the one or more wavelengths is still outside of the set tolerance of the stored value of the parameter, the method comprises indicating that the optical sensor is not ready for use.
9. The method as described in any preceding clause, wherein the set tolerance is up to ±5%.
10. The method as described in any preceding clause, wherein the method comprises facing the one or more detectors and one or more light sources towards a reflective surface with known properties.
11. The method as described in any preceding clause, wherein the method comprises covering the one or more detectors and one or more light sources with a reflective cover.
12. The method as described in clause 11, wherein the method comprises covering the one or more detectors and one or more light sources with the reflective cover before the steps of emitting one or more light pulses at one or more different wavelengths using the one or more light sources, and recording the signal for the one or more light pulses at each wavelength using the one or more detectors.
13. The method as described in any preceding clause, wherein detection of the one or more light pulses at a plurality of different wavelengths by the one or more detectors is time multiplexed according to the emission of each wavelength of light.
14. The method as described in any preceding clause, wherein if the optical sensor comprises multiple light sources for emitting light pulses of the same wavelength, the method comprises emitting each the light pulses of the same wavelength from different light sources simultaneously.
15. The method as described in any of clauses 1 to 13, wherein if the optical sensor comprises multiple light sources for emitting light pulses of the same wavelength, the method comprises emitting each of the light pulses of the same wavelength sequentially.
16. The method as described in any preceding clause, wherein the optical sensor is a medical device for measuring one or more physiological signs of a patient.
17. The method as described in clause 16, wherein the medical device is a pulse oximeter.
18. The method as described in any preceding clause, wherein the optical sensor is a wearable device for measuring one or more physiological signs of a person.
19. The method as described in clause 18, wherein the wearable device is a smart watch or sports watch.
20. The method as described in any preceding clause, wherein the one or more detectors comprises a photodetector.
21. The method as described in any preceding clause, wherein the one or more detectors comprises a camera.
22. The method as described in any preceding clause, wherein the parameter is signal-to-noise ratio.
23. The method as described in any preceding clause, wherein the one or more physiological signs comprise one or more vital signs.
24. An optical sensor for measuring one or more physiological signs of a person, the sensor comprising one or more detectors and one or more light sources, wherein prior to the device being attached to the person, the optical sensor is configured to: emit one or more light pulses at one or more different wavelengths using the one or more light sources, wherein each light pulse is emitted at a known power level for a known length of time; record the signal for the one or more light pulses at each wavelength using the one or more detectors; determine a parameter for each signal at each wavelength of light; compare the determined parameter to a stored value of the parameter for each wavelength; and determine that the optical sensor is ready for use if the determined parameter for each wavelength is within a set tolerance of the stored value of the parameter for each wavelength.
25. An optical sensor according to clause 24, wherein the optical sensor is configured to perform the method of any of clauses 1 to 23.
26. A method of calibrating an optical sensor for measuring one or more physiological signs of a person, the sensor comprising one or more detectors and one or more light sources, the method comprising the following steps after the device is attached to the person: emitting one or more light pulses at one or more wavelengths using one or more of the one or more light sources, wherein each light pulse at each wavelength is emitted at a known power level and for a known length time; recording a signal for the one or more light pluses at each wavelength using the one or more detectors; determining a parameter for each signal at each wavelength of light; comparing the determined parameter to a stored value of the parameter for each wavelength of light; and adjusting the power and/or length of time of the one or more light pulses at each wavelength to reduce the difference between the determined parameter and the stored value of the parameter.
27. The method as described in clause 26, wherein the method comprises emitting light pulses at a plurality of different wavelengths.
28. The method as described in clause 26 or 27, wherein the stored value of the parameter is dependent on the one or more light sources and/or one or more detectors and determined under predefined conditions.
29. The method as described in clause 26, 27 or 28, wherein the known power level and known length of time are values from which the power can be both increased or decreased and from which the length of time can be both increased and decreased.
30. The method as described in any of clauses 26 to 29 wherein the method comprises adjusting only one of the power and/or length of time of the light pulse(s) for each wavelength.
31. The method as described in any of clauses 26 to 30, wherein the method comprises adjusting the power and/or length of time of the light pulse for each wavelength independently.
32. The method as described in clause 31, wherein one of the power and/or time is increased, and the other of the power and/or time is decreased.
33. The method as described in any of clauses 26 to 32, wherein the method comprises attaching the optical sensor to the skin of the person.
34. The method as described in any of clauses 26 to 33, wherein the optical sensor comprises multiple light sources configured to emit light pulses of the same wavelength, and the method comprises emitting each of the light pulses of the same wavelength from different light sources simultaneously.
35. The method as described in any of clauses 26 to 34, wherein the method comprises determining a difference between a determined parameter to the stored value of the parameter for each wavelength of light.
36. The method as described in clause 35, wherein the method comprises comparing a difference between a determined parameter to the stored value of the parameter for each wavelength of light to a predetermined tolerance.
37. The method as described in clause 36, wherein the method comprises adjusting the power and/or length of time of the light pulses at each wavelength to reduce the difference to be within the predetermined tolerance.
38. The method as described in clause 36 or 37, wherein the method comprises adjusting the power and/or length of time of the light pulse only for the wavelengths where the difference between the determined parameter and the stored value of the parameter for one or more of the plurality of wavelengths is outside the predetermined tolerance.
39. The method as described in clause 36, 37 or 38, wherein the predetermined tolerance is up to ±20% of the stored value of the parameter.
40. The method as described in any one of clauses 36 to 39 wherein the method comprises indicating that the optical sensor is calibrated and/or ready for use once the difference between the determined parameter and the stored value of the parameter for each wavelength is within the predetermined tolerance.
41. The method as described in any of clauses 26 to 40, wherein following the step of adjusting the power and/or time of the light pulses at each wavelength, the method comprises repeating one or more times the steps of emitting one or more light pulses at a one or more different wavelengths using the one or more light sources, recording the signal for the one or more light pulses at each wavelength using the detector; determining a parameter for each signal at each wavelength of light; and comparing the determined parameter to a stored value of the parameter for each wavelength.
42. The method as described in clause 41, wherein the repeated steps comprise emitting the one or more light pulses at the adjusted power level and/or for the adjusted length of time.
43. The method as described in any of clauses 26 to 42, wherein the method comprises recording a signal for the one or more light pluses at each wavelength using one or more detectors to create an optical signature of the person.
44. The method as described in clause 43, wherein the method comprises comparing the optical signature of the person to a library of stored optical signatures in order to select one or more wavelengths to be used when measuring the one or more physiological signs.
45. The method as described in clause 44, wherein the library of optical signatures is organized into a plurality of skin profile categories, wherein each skin profile category has a predetermined one or more wavelengths to be used when measuring the one or more physiological signs, and wherein comparing the optical signature of the person to the library includes assigning a skin profile category to the person and selecting the one or more wavelengths to be used when measuring the one or more physiological signs based on the assigned skin profile category.
46. The method as described in clause 45, wherein the steps of determining the parameter for each signal at each wavelength of light, comparing the determined parameter to a stored value of the parameter for each wavelength of light, and adjusting the power and/or time of the light pulses at each wavelength to reduce the difference between the determined parameter and the stored value of the parameter is only carried out for the one or more selected wavelengths.
47. The method as described in any of clauses 26 to 46, wherein the optical sensor is a medical device, such as a pulse oximeter, for measuring one or more vital signs of a patient, or a wearable device, such as a sports watch, for measuring one or more physiological signs of a person.
48. The method as described in any of clauses 26 to 47, wherein the parameter is signal-to-noise ratio.
49. An optical sensor for measuring one or more physiological signs of a person, the sensor comprising one or more detectors and one or more light sources, wherein once the device is attached to the person, the optical sensor is configured to: emit one or more light pulses at one or more different wavelengths using one or more of the one or more light sources, wherein each light pulse at each wavelength is emitted at a known power level and for a known length time; record a signal for the light pluses at each wavelength using the one or more detectors; determine a parameter for each signal at each wavelength of light; compare the determined parameter to a stored value of the parameter for each wavelength of light; and adjust the power and/or time of the light pulses at each wavelength to reduce the difference between the determined parameter and the stored value of the parameter.
50. An optical sensor of clause 49, wherein the optical sensor is configured to perform the method of any of clauses 26 to 48.

1. A method of calibrating an optical sensor for measuring one or more physiological signs of a person after the device is attached to the person, the sensor comprising one or more detectors and one more light sources, the method comprising the following steps after the device is attached to the person:
emitting one or more light pulses at a plurality of different wavelengths using one or more light sources, wherein each light pulse at each wavelength is emitted at a known power level and for a known length time;
recording a signal for the light pulses at each wavelength using one or more detectors to create an optical signature of the person;
selecting one or more wavelengths of the plurality of wavelengths based on the optical signature of the person to be used when measuring the one or more physiological signs.

2. A method according to claim 1, wherein the method comprises comparing the optical signature of the person to a library of stored optical signatures in order to select the one or more wavelengths to be used when measuring the one or more physiological signs.

3. A method according to claim 2, wherein the library of optical signatures is organised into a plurality of skin profile categories, wherein each skin profile category has a predetermined one or more wavelengths to be used when measuring the one or more physiological signs, and wherein comparing the optical signature of the person to the library includes assigning a skin profile category to the person and selecting the one or more wavelengths to be used when measuring the one or more physiological signs based on the assigned skin profile category.

4. A method according to any preceding claim, wherein the method comprises determining a parameter for each recorded signal of each wavelength.

5. A method according to claim 4, wherein the method comprises comparing the determined parameter to a stored value of the parameter for each wavelength of light.

6. A method according to claim 5, wherein the method comprises determining a difference between the determined parameter to the stored value of the parameter for each wavelength of light.

7. A method according to claim 5 or 6, wherein the method comprises adjusting the power and/or time of one or more of the light pulses at each wavelength to reduce the difference between the determined parameter and the stored value of the parameter.

8. A method according to claim 7, wherein the steps of determining the parameter for each wavelength; comparing the determined parameter to a stored value of the parameter for each wavelength of light; determining a difference between the determined parameter to a stored value of the parameter for each wavelength of light; and adjusting the power and/or time of the light pulses at each wavelength to reduce the difference between the determined parameter and the stored value of the parameter are carried out only for the one or more wavelengths selected to be used in measuring the one or more physiological signs.

9. The method as claimed in any preceding claim, wherein the optical sensor is a medical device for measuring one or more physiological signs of a patient.

10. The method as claimed in claim 9, wherein the medical device is a pulse oximeter.

11. The method as claimed in any preceding claim, wherein the optical sensor is a wearable device for measuring one or more physiological signs of a person.

12. The method as claimed in claim 11, wherein the wearable device is a smart watch or sports watch.

13. The method as claimed in any preceding claim, wherein the one or more detectors comprises a photodetector.

14. The method as claimed in any preceding claim, wherein the one or more detectors comprises a camera.

15. The method as claimed in any preceding claim, wherein the parameter is signal-to-noise ratio.

16. An optical sensor for measuring one or more physiological signs of a person, the optical sensor comprising:
one or more detectors; and
one or more light sources,
wherein once the device is attached to the person, the optical sensor is configured to:
emit light pulses at a plurality of different wavelengths using one or more light sources, wherein each light pulse at each wavelength is emitted at a known power level and for a known length time;
record a signal for the light pluses at each wavelength using the one or more detectors to create an optical signature of the person; and
select one or more wavelengths of the plurality of wavelengths based on the optical signature of the person to be used when measuring the one or more physiological signs.

17. An optical sensor according to claim 16, wherein the optical sensor is configured to perform the method of any of claims 1 to 15.

18. A method of initialising an optical sensor for measuring one or more physiological signs of a person, the sensor comprising one or more detectors and one more light sources, the method comprising the following steps before the device is attached to the person:
emitting one or more light pulses at one or more different wavelengths using the one or more light sources, wherein each light pulse is emitted at a known power level for a known length of time;
recording the signal for the one or more light pulses at each wavelength using the one or more detectors;
determining a parameter for each signal at each wavelength of light;
comparing the determined parameter to a stored value of the parameter for each wavelength; and
determining that the optical sensor is ready for use if the determined parameter for each wavelength is within a set tolerance of the stored value of the parameter for each wavelength.

19. A method of calibrating an optical sensor for measuring one or more physiological signs of a person, the sensor comprising one or more detectors and one or more light sources, the method comprising the following steps after the device is attached to the person:
emitting one or more light pulses at one or more wavelengths using one or more of the one or more light sources, wherein each light pulse at each wavelength is emitted at a known power level and for a known length time;
recording a signal for the one or more light pluses at each wavelength using the one or more detectors;
determining a parameter for each signal at each wavelength of light;
comparing the determined parameter to a stored value of the parameter for each wavelength of light; and
adjusting the power and/or length of time of the one or more light pulses at each wavelength to reduce the difference between the determined parameter and the stored value of the parameter.
